(19) United States
(12) Patent Application Publication
(10) Pub. No.: US 2013/0285966 A1
(43) Pub. Date: Oct. 31, 2013

(54) DISPLAY APPARATUS

(71) Applicants: Tomohiro Kimura, Osaka-shi (JP); Kohji Fujiwara, Osaka-shi (JP); Akiko Miyazaki, Osaka-shi (JP); Toshiharu Kusumoto, Osaka-shi (JP)

(72) Inventors: Tomohiro Kimura, Osaka-shi (JP); Kohji Fujiwara, Osaka-shi (JP); Akiko Miyazaki, Osaka-shi (JP); Toshiharu Kusumoto, Osaka-shi (JP)

(73) Assignee: SHARP KABUSHIKI KAISHA, Osaka-shi, Osaka (JP)

(21) Appl. No.: 13/976,149

(22) PCT Filed: Dec. 21, 2011
(86) PCT No.: PCT/JP2011/079593

§ 371 Date: Jun. 26, 2013

(30) Foreign Application Priority Data
Dec. 28, 2010 (JP) 2010-294103

(51) Int. Cl. G06F 3/041

(52) U.S. Cl. CPC G06F 3/041
USPC 345/173

(57) ABSTRACT

A display apparatus (1) having a touch panel function has a display screen (21) and multiple touch sensors (10) to detect the contact position of a user to the display screen (21), and the touch sensor (10) has a first sensor group (11a) of which the sensitivity to detect the user instruction position to the display screen (21) is relatively low, and a second sensor group (11b) of which the sensitivity to detect the user instruction position to the display screen (21) is relatively high compared to the first sensor group (11a). Thus, a display apparatus is provided having a touch panel function preventing poorer user usability, and which reduces power consumption.

### TECHNICAL FIELD

The present invention relates to a display apparatus having a touch panel function in which position input and image display can be performed.

### BACKGROUND ART

A display having a touch panel function has been used conventionally.

For example, in PTL 1 is disclosed a cellular phone that uses a display unit which displays multiple windows within one display unit. The cellular phone in PTL 1 has a touch sensor disposed over the entire face of one display unit. A window corresponding to the position of the touch sensor that detects the touch of the user is controlled according to the touch of the user.

Also, in PTL 2 is disclosed a display device, which uses a portion of the region that is one display region to perform text and image display, of a liquid crystal panel, as a tablet input region. The tablet input region is configured by an electromagnetically conducting tablet in which multiple sensor coils are disposed is disposed on the back face side of the liquid crystal panel. By outputting high frequencies from an input pen, current is generated in the sensors within the electromagnetic conducting tablet, and the coordinates of the pen tip of the input pen is detected in accordance with intensity of this current.

### CITATION LIST

### Patent Literature

PTL 1: Japanese Unexamined Patent Application Publication No. 2010-231653 (Disclosed Oct. 14, 2010)
PTL 2: Japanese Unexamined Patent Application Publication No. 2006-260366 (Disclosed Sep. 28, 2006)

### SUMMARY OF INVENTION

### Technical Problem

Now, a display having a touch panel function is requested to have improvements to both the sensor sensitivity of the touch panel and suppression of power consumption.

However, if driving to increase the sensitivity of the touch panel sensor (e.g. raising the driving frequency) is performed, power consumption increases greatly. On the other hand, if the driving frequency of the touch panel sensor is lowered to reduce power consumption, the sensitivity of the touch panel sensor is reduced, making usability for the user poor.

In such a case, improving the sensor sensitivity of the touch panel and suppressing the power consumption are in a tradeoff relationship.

According to the cellular phone in PTL 1, upon the driving frequency of the touch sensor that is disposed over the entire display unit being lowered in order to suppress the power consumption of the touch sensor, the sensor sensitivity of the touch sensor over the entire display unit is decreased, making usability poor for the user.

According to the display apparatus in PTL 2 also, upon the position detecting sensitivity of the entire electromagnetic tablet being decreased in order to suppress power consumption, usability is made poor for the user.

The present invention is made to solve the above-mentioned problem points, and the objective thereof is to provide a display apparatus having a touch panel function that prevents difficulty in use for the user and decreases power consumption.

### Solution to Problem

In order to solve the above problems, a display apparatus having a touch panel function has a display screen to display an image; and multiple position detecting sensors to detect the instruction position of a user to the display screen; wherein the multiple position detecting sensors have multiple first position detecting sensors having a relatively low sensitivity to detect the instruction position of a user to the display screen; and multiple second position detecting sensors having a relatively high sensitivity to detect the instruction position of the user to the display screen, as compared to the multiple first position detecting sensors.

According to the above configuration, multiple position detecting sensors are provided, whereby the instruction position of the user to the display screen can be detected.

Also, according to the above configuration, the multiple position detecting sensors have a first position detecting sensor group having a relatively low sensitivity to detect the user instruction position to the display screen. Thus, power consumption can be reduced as compared to the case of being formed from only position detecting sensors having high sensitivity to detect the user instruction position to the display screen.

Further, according to the above configuration, the multiple position detecting sensors have a second position detecting sensor having relatively higher sensitivity than the first position detecting sensor, to detect the user instruction position to the display screen.

Thus, on the display screen, with the second position detecting sensor, an image to accept input from the user (hereafter called an input image) is primarily displayed in a region to detect the user contact position to the display screen, thereby preventing poor usability due to decreased sensitivity to detect the user contact position.

Thus, according to the above configuration, a display apparatus having a touch panel function in which poor usability for the user is prevented, and which reduces power consumption, is provided.

### Advantageous Effects of Invention

A display apparatus according to the present invention is a display apparatus having a touch panel function, which has a display screen to display an image and multiple position detecting sensors to detect the instruction position of a user to the display screen; wherein the multiple position detecting sensors have multiple first position detecting sensors having a relatively low sensitivity to detect the instruction position of a user to the display screen; and multiple second position detecting sensors having a relatively high sensitivity to detect the instruction position of the user to the display screen, as compared to the multiple first position detecting sensors.

Thus, a display apparatus having a touch panel function in which usability is poor for the user is prevented, and which reduces power consumption, is provided.

### BRIEF DESCRIPTION OF DRAWINGS

FIG. 1 is a plan view illustrating a configuration of a display apparatus according to a first embodiment of the present invention.

FIG. 2 is a cross-sectional view illustrating a configuration of a display apparatus according to the present invention.

FIG. 3 is a diagram illustrating a configuration of a touch sensor of the display apparatus according to the present invention.

FIG. 4 is a diagram describing operations of the touch sensor of the display apparatus according to the present invention.

FIG. 5 is a plan view illustrating a configuration of a sensor electrode (X) and a sensor electrode (Y) sensor of the display apparatus according to the present invention.

FIG. 6 is a diagram to describe an equivalent circuit of the touch sensor of the display apparatus according to the present invention.

FIG. 7 is a block diagram illustrating a configuration of the display apparatus according to the present invention.

FIG. 8 is a diagram describing an operating principle of the touch sensor of the display apparatus according to the present invention.

FIG. 9 is a block diagram illustrating a configuration of the display apparatus according to the first embodiment of the present invention.

FIG. 10 is a block diagram illustrating a processing flow of the display apparatus according to the first embodiment of the present invention.

FIG. 11 is a diagram describing a usage example of the display apparatus according to the present invention.

FIG. 12 is a diagram describing a usage example of the display apparatus according to the present invention.

FIG. 13 is a cross-sectional diagram illustrating a configuration of an on-cell type touch panel which is a display apparatus according to the present invention.

FIG. 14 is a cross-sectional diagram illustrating a configuration of an on-cell type touch panel which is a display apparatus according to the present invention.

FIG. 15 is a cross-sectional diagram illustrating a configuration of an in-cell type touch panel which is a display apparatus according to the present invention.

FIG. 16 is a cross-sectional diagram illustrating a configuration of an in-cell type touch panel which is a display apparatus according to the present invention.

FIG. 17 is a plan view illustrating a configuration of a display apparatus according to a second embodiment of the present invention.

FIG. 18 is a block diagram illustrating a configuration of the display apparatus according to the second embodiment of the present invention.

FIG. 19 is a block diagram illustrating a processing flow of the display apparatus according to the second embodiment of the present invention.

FIG. 20 is a block diagram illustrating a configuration of a display apparatus according to a third embodiment of the present invention.

FIG. 21 is a cross-sectional diagram illustrating a configuration of a third display apparatus according to the present invention.

FIG. 22 is a block diagram illustrating a processing flow of the display apparatus according to the third embodiment of the present invention.

### DESCRIPTION OF EMBODIMENTS

Embodiments of the present invention will be described.

Note that in the descriptions below, description is given for a capacitance method (first and second embodiments) and optical sensor method (third embodiment) both detecting a touch (contact) of a finger or the like of a user to a display screen, but the touch (contact) also includes a state wherein the finger or the like of the user is not completely touching (contacting) the display screen, and the finger or the like of the user is separated from the display screen at a distance at which a detecting sensor can detect (spatial detection).

That is to say, with a touch sensor, spatial detection can be made by arrangements such as increasing a signal. For example, if a pulse voltage is large, sensing of a finger or the like of a user can be performed even at a distance of several centimeters from an input face. Therefore, sensor principles are the same and not restricted to touching (contact).

### First Embodiment

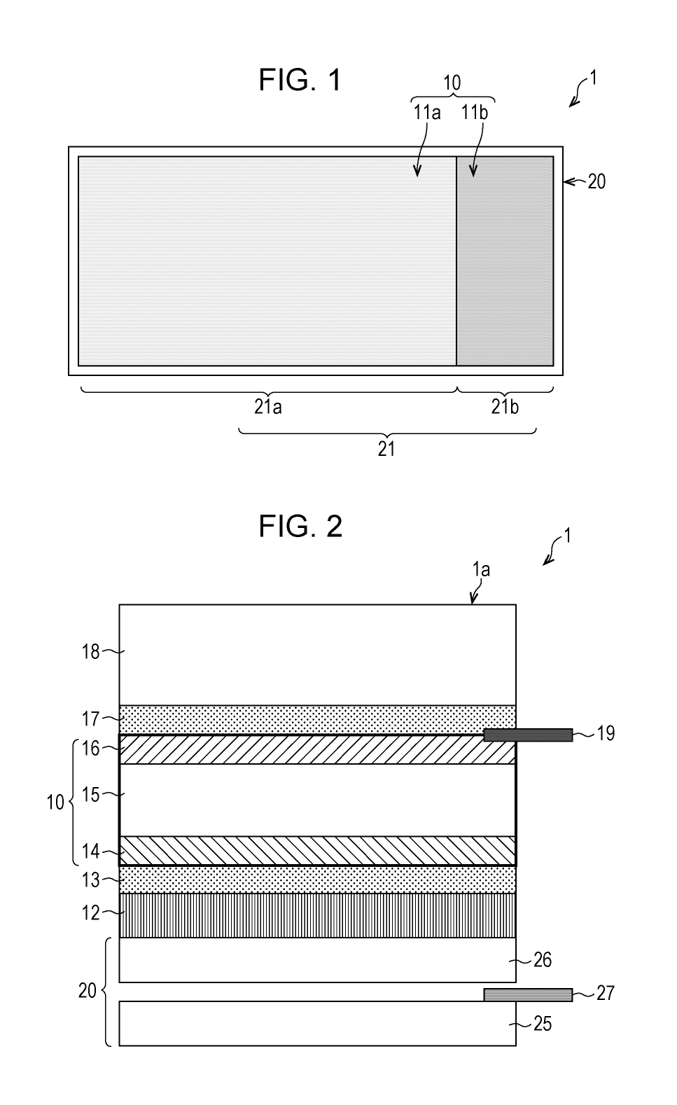

A first embodiment of the present invention will be described with reference to FIGS. 1 through 16.

### (Configuration of Display Apparatus 1)

First, a basic configuration of a display apparatus 1 according to the present invention will be described with reference to FIG. 1 and FIG. 2.

FIG. 1 is a plan view illustrating the configuration of the display apparatus 1 relating to an embodiment of the present invention.

The display apparatus 1 is a display apparatus having a touch panel function that can detect contact position (instruction position) of an input pointer of a user, such as a finger or pen or the like (hereinafter called input pointer), and can display an image. The display apparatus 1 is a projection-type of touch panel apparatus of a capacitance method.

The display apparatus 1 has a liquid crystal panel 20 having a display screen 21 to display an image, and a touch sensor 10 (multiple position detecting sensors) to detect contact positions of an input pointer of the user to the display screen 21. Further, the display apparatus 1 has driving circuits to drive each of the liquid crystal panel 20 and touch sensor 10.

The display screen 21 is configured with a first display region 21a and a second display region 21b in which image display from mutually different picture signals can be performed.

Note that according to the configuration of the present embodiment, the areas of each of the first display region 21a and second display region 21b of the display screen 21 are fixed beforehand and are not changeable.

The touch sensor 10 is disposed within the display screen 21 when viewing the display apparatus 1 in plan view.

The touch sensor 10 detects contact position (instruction position) of the input pointer of the user to the display screen 21 with the capacitance method. Therefore, since the cost is lower as compared to a case of realizing the touch panel function with an electromagnetic conducting method or the like, large increases to the manufacturing costs may be suppressed.

The touch sensor 10 has a first detecting sensor (first position detecting sensor) 11a disposed on the first display region 21a, and a second detecting sensor (second position detecting sensor) 11b disposed on the second display region 21b.

In the display apparatus 1, detection sensitivity to detect contact with the display screen 21 differs between the first detecting sensor 11a and the second detecting sensor 11b.

According to the present embodiment, the first detecting sensor 11a is a sensor having a relatively low sensitivity to detect the contact position of the input pointer of the user to the display screen 21. On the other hand, the second detecting sensor 11b is a sensor having a relatively high sensitivity to detect the contact position of the input pointer of the user to the display screen 21.

Also, according to the present embodiment, the detecting sensitivity of the first detecting sensor 11a and the detecting sensitivity of the second detecting sensor 11b are configured so as to be changeable.

Note that the configuration of the touch sensor 10 will be described below.

The first display region 21a is a region having an area that is relatively larger than the second display region 21b. The first display region 21a is a region to primarily display images of content which are mainly for a user to observe.

In other words, as compared to the second display region 21b, the first display region 21a is a region having a high ratio of displaying images of content for the user to observe.

The second display region 21b is a region having an area that is relatively smaller than the first display region 21a. The second display region 21b is a region to primarily display images to obtain input from the user, serving as a user interface (UI) such as a button or the like for content selection.

In other words, as compared to the first display region 21a, the second display region 21b is a region having a high ratio of display images that function as a UI.

FIG. 2 is a cross-sectional diagram illustrating a configuration of the display apparatus 1.

The display apparatus 1 is an out-cell type touch panel apparatus.

The display apparatus 1 has a touch sensor 10 disposed on the surface of the liquid crystal panel 20. The liquid crystal panel 20 has a has a TFT glass substrate 25 on which TFT to perform switching for each pixel is disposed for each pixel, and a facing glass substrate 26 which is disposed facing the TFT glass substrate 25 via a liquid crystal layer. Also, one end portion of a FPC (flexible printed circuit board) 27 is disposed between the TFT glass substrate 25 and the facing glass substrate 26.

Also, the display apparatus 1 is configured, layered in order from the bottom layer side to the top layer side, a polarizer 12, optical adhesive 13, sensor electrode (Y) 14, TP (touch panel) glass plate 15, sensor electrode (X) 16, optical adhesive 17, and cover glass 18. Also, one end portion of a FPC (flexible printed circuit board) 29 is disposed in a form to connect to the sensor electrode (X) 16 and sensor electrode (Y) 14.

The film thickness of the members may be approximate, for example, 0.2 mm for the polarizer 12, 0.2 mm for the optical adhesive 13, 0.6 mm for the sensor electrode (Y) 14 and glass substrate 15 and sensor electrode (X) 16 together, 0.2 mm for the optical adhesive 17, and 0.8 mm for the cover glass 18.

Note that, although not shown in the diagram, a polarizer and back light are disposed on the back face of the liquid crystal panel 20.

The surface of the cover glass 18 is a touch face (contact face) 1a for the user to touch (contact) with a finger or pen or the like to input position.

The cover glass 18 and glass substrate 15 are not necessarily made of glass material, and for example, may be made of a transparent resin material such as an acrylic resin or the like.

The sensor electrode (X) 16 and sensor electrode (Y) 14 are made of a transparent conductive material such as ITO or the like.

The touch sensor 10 is configured of the sensor electrode (X) 16 and sensor electrode (Y) 14. Upon the input pointing making contact with the touch face 1a, the touch sensor 10 detects the position where the capacitance has changed between the sensor electrode (X) 16 and sensor electrode (Y) 14, thereby detecting the coordinates of the input pointer that is in contact with the touch face 1a.

### (Configuration of Touch Sensor)

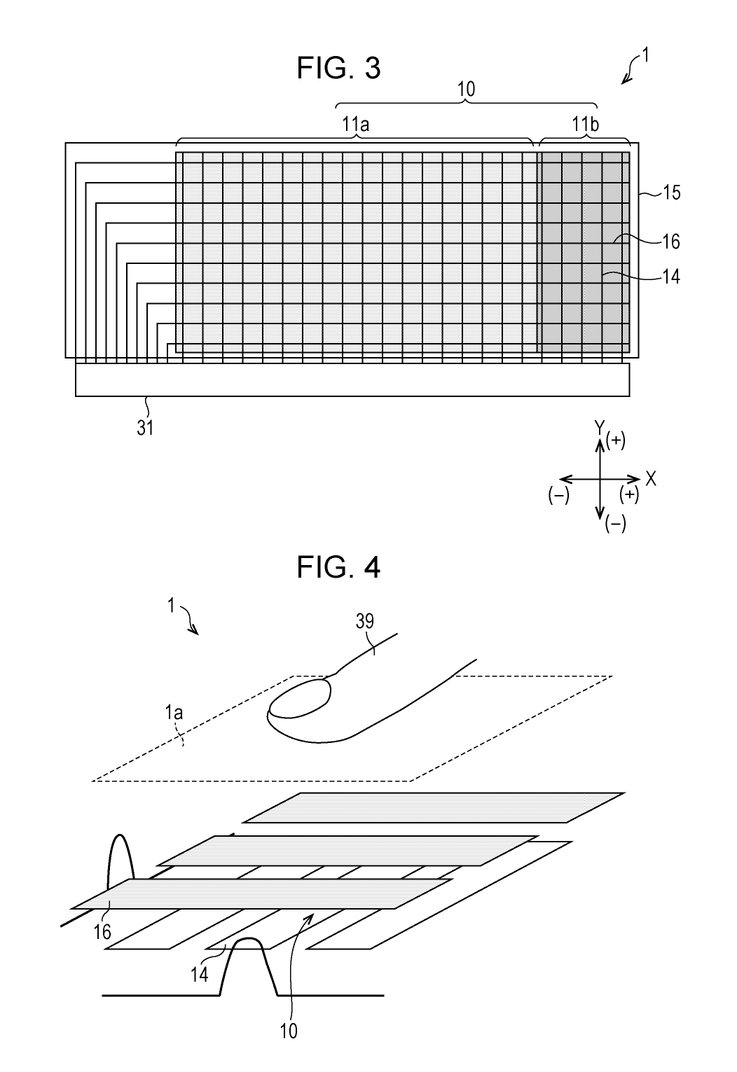

Next, the configuration of the touch sensor 10 will be described. FIG. 3 is a diagram illustrating the configuration of the touch sensor 10 of the display apparatus 1.

The touch sensor 10 has a first detecting sensor 11a which is disposed so as to be layered on the first display region 21a, and a second detecting sensor 11b which is disposed so as to be layered on the second display region 21b.

Multiple sensor electrodes (X) 16 disposed on the front face of the glass substrate 15 are disposed parallel to each other, and are arranged in the horizontal direction (X-direction). That is to say, each of the multiple sensor electrodes (X) 16 are extended in the horizontal direction (X-direction), and arrayed in the vertical direction (Y-direction).

Also, the multiple sensor electrodes (Y) 14 disposed on the back face of the glass substrate 15 are disposed parallel to each other, and are arranged in the vertical direction (Y-direction). That is to say, each of the multiple sensor electrodes (Y) 14 are extended in the vertical direction (Y-direction), and arrayed in the horizontal direction (X-direction).

The touch sensor 10 is configured by the multiple sensor electrodes (X) 16 and the multiple sensor electrodes (Y) 14 intersecting.

The multiple sensor electrodes (X) 16 and multiple sensor electrodes (Y) 14 are connected to the sensor driver 31 (described later), via an FPC 19 (unshown in FIG. 3).

The multiple sensor electrodes (X) 16 are connected by drawing lines to the FPC 19 (unshown in FIG. 3). The multiple sensor electrodes (X) are connected to the sensor driver 31 via the FPC 19 (unshown in FIG. 3).

The multiple sensor electrodes (Y) 14 are connected by drawing lines to the FPC 19 (unshown in FIG. 3). The multiple sensor electrodes (Y) 14 are connected to the sensor driver 31 via the FPC 19 (unshown in FIG. 3).

The touch sensor 10 is made up of the first detecting sensor 11a disposed on the first display region 21a and the second detecting sensor 11b disposed on the second display region 21b.

Of the intersecting portions of the sensor electrode (X) 16 and the sensor electrode (Y) 14, the portion disposed within the first display region 21a is the first detecting sensor 11a, and the portion included within the second display region 21b is the second detecting sensor 11b.

With the display apparatus 1, the frequency of the driving signal, output to the first detecting sensor 11a from the sensor driver 31, is caused to be lower than the frequency of the driving signal output to the second detecting sensor 11b, whereby the sensitivity to detect the contact position of the input pointer of the user to the display screen 21, by the first detecting sensor 11a, is relatively low.

FIG. 4 is a diagram to describe operations of the touch sensor 10.

As illustrated in FIG. 4, a driving signal is output from the sensor driver 31 to the multiple sensor electrodes (Y) 14. Upon the input pointer 39, which is a finger or the like of the user, makes contact with the touch face 1a, the capacitance between the sensor electrodes (X) 16 and the sensor electrodes (Y) 14 near the input pointer 39 in contact changes.

Thus, the contact position of the input pointer 39 of the user to the display screen 21 is detected by the touch sensor 10. Upon the contact position of the input pointer of the user to the display screen 21 being detected by the touch sensor 10, the waveform of the output signal that is output from the sensor electrode (X) 16 of the detected position to the sensor driver 31 changes.

The sensor driver 31 identifies the portion of the output signal waveform that is changed by the touch sensor 10 detecting contact of the input pointer 39, of the output signals output from the multiple sensor electrodes (X) 16, whereby the display apparatus 1 can obtain the contact position of the input pointer 39.

As an example, the pitch of the sensor electrodes (X) 16 and the sensor electrodes (Y) 14 is approximately 5 mm.

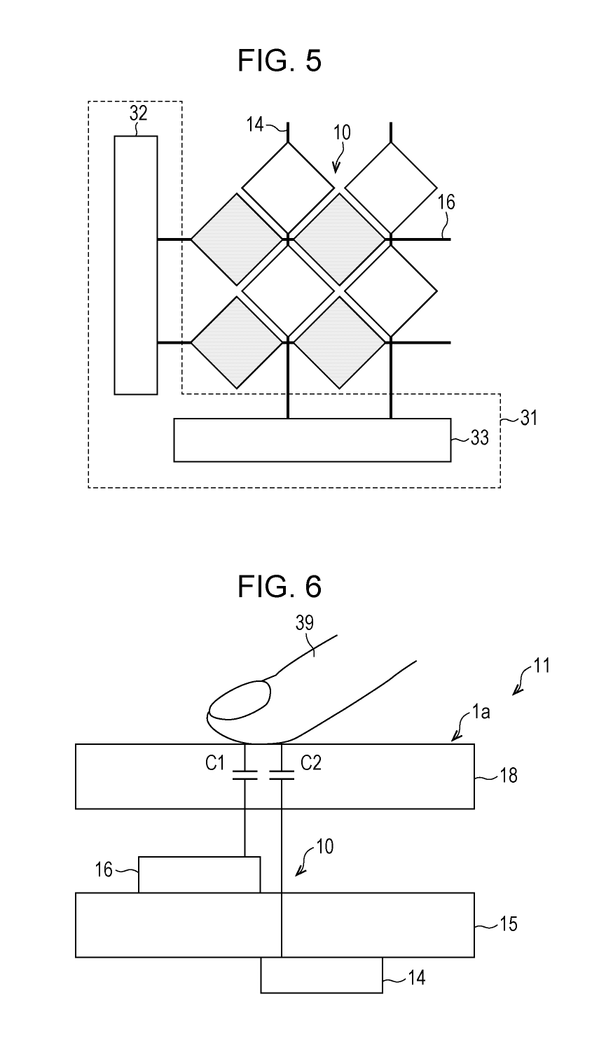

FIG. 5 is a plan view illustrating a configuration of the sensor electrodes (X) 16 and the sensor electrodes (Y) 14.

As illustrated in FIG. 5, the sensor electrodes (X) 16 are configured so that multi-angle portions having a multi-angle shape, such as a diamond shape or the like, are continuously disposed in the extension direction (extending direction) of the sensor electrodes (X) 16, and are mutually connected electrically.

Similarly, the sensor electrodes (Y) 14 are configured so that multi-angle portions having a multi-angle shape, such as a diamond shape or the like, are continuously disposed in the extension direction (extending direction) of the sensor electrodes (Y) 14, and are mutually connected electrically.

Thus, the touch sensor 10 is configured by the multiple sensor electrodes (X) 16 and the multiple sensor electrodes (Y) 14 intersecting.

Note that the multi-angle portions mentioned above of the sensor electrodes (X) 16 and the sensor electrodes (Y) 14 are not limited to diamond shapes, and any multi-angle shape having five or more angles may be used, and may be a triangle, or further, may be a circular shape or an oval shape.

One of the end portions of the sensor electrode (X) 16 is connected to a detecting circuit 33 (described later) which the sensor driver 31 has, and one of the end portions of the sensor electrode (Y) 14 is connected to a driving circuit 32 which the sensor driver 31 has.

### (Summary Description of Block and Operation of Display Apparatus 1)

Let us say that the detection method of capacitance of the display apparatus 1 according to the present embodiment is a so-called Grid method.

With a Grid method touch sensor 10, an electrical field is created in the touch face 1a. With the sensor electrode (X) 16 and sensor electrode (Y) 14, the position of the input pointer 39 is identified from the cumulative data of voltage changes occurring in the capacity of the input pointer 39 such as a finger or the like that has made contacted with the touch face 1a or neared the touch face 1a.

FIG. 6 is an outline diagram of the cross-section of the touch sensor 10 to describe an equivalent circuit of the touch sensor 10.

As illustrated in FIG. 6, in a region where the touch sensor 10 is formed, i.e. in a region where the sensor electrode (X) 16 and sensor electrode (Y) 14 intersect, we may consider that a capacitance C1 is disposed between the sensor electrode (X) 16 and the touch face 1a and a capacity C2 is disposed between the sensor electrode (Y) 14 and the touch face 1a. That is to say, the touch sensor 10 has a capacitance C1 and a capacitance C2.

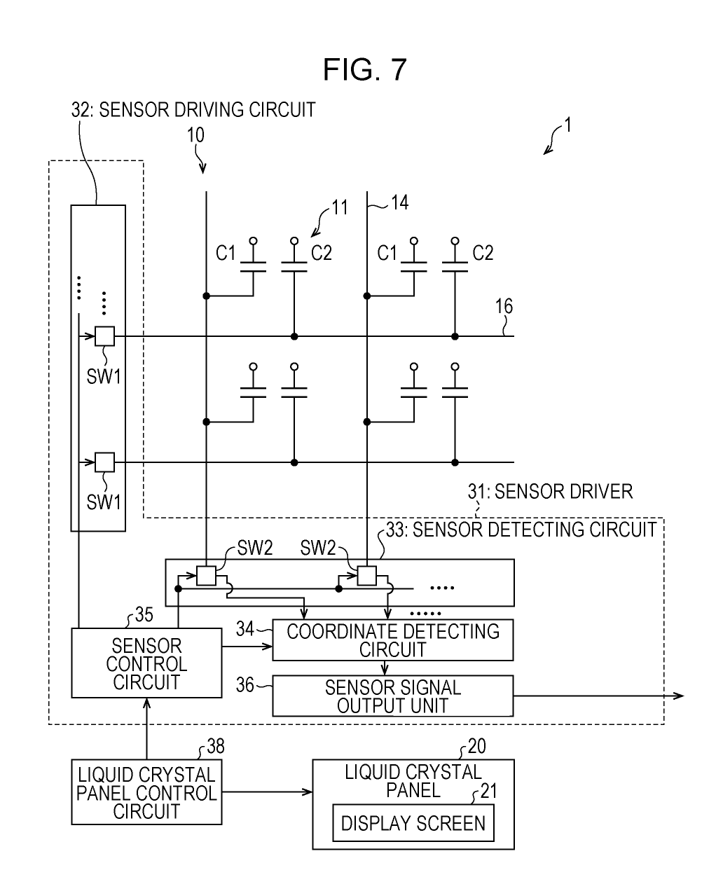

FIG. 7 is a block diagram illustrating a schematic configuration of the display apparatus 1.

The display apparatus 1 has a sensor driver 31 to control the driving of the sensor electrodes (X) 16 and sensor electrodes (Y) 14 of the touch sensor 10, a liquid crystal panel 20 having a display screen 21, and a liquid crystal panel control circuit 38 to control the driving of the liquid crystal panel 20.

The touch sensor 10 has a capacitance C1, one end of which is connected to a sensor electrode (X) 16 and the other end of which is an open end, and a capacitance C2, one end of which is connected to a sensor electrode (Y) 14 and the other end of which is an open end. The capacitance C1 and capacitance C2 included together are called the detecting sensor 11. Note that the detecting sensor 11 is configured of a first detecting sensor 11a and a second detecting sensor 11b.

The sensor driver 31 has a sensor driving circuit 32, sensor detecting circuit 33, coordinates detecting circuit 34, sensor control circuit 35, and sensor signal output unit 36.

The sensor driving circuit 32 has switches SW1 that are connected to one end of the sensor electrodes (X) 16 and are disposed in an array.

The sensor driving circuit 33 has switches SW2 that are connected to one end of the sensor electrodes (Y) 14 and are disposed in an array.

The liquid crystal panel control circuit 38 obtains image display content to display an image on the display screen 21. For example, the display apparatus 1 obtains a digital television signal received from the outside via an antenna provided to the apparatus thereof as image display content, or obtains software stored within the display apparatus 1 as image display content from the outside.

According to the input from the user that operates the display apparatus 1, the liquid crystal panel control circuit 38 outputs image display instruction information to display the obtained image display content image to the liquid crystal panel 20, and determines whether or not position input request information to accept the position input from the user is included in the image display content.

The position input request information is information indicating that an image to request position input by the user touching with the input pointer 38, such as a selection button or the like displayed on the user interface image or the like, is included.

The liquid crystal panel control circuit 38 determines whether or not position input request information is included in each of the image display content to display an image in the first display region 21a and image display content to display an image in the second display region 21b.

Upon determining that position input request information is included in the image display content, the liquid crystal panel control circuit 38 outputs sensor driving instruction information to drive the detecting sensor 11 to the sensor control circuit 35 as a determination result.

Note that, in the case that the second detecting sensor 11b is driven constantly at a fixed detection sensitivity, the liquid crystal panel control circuit 38 may determine whether or not position input request information is included in the image display content to display in only the first display region 21a, of the first display region 21a and second display region 21b.

Also, upon determining that position input request information is included in the image display content, the liquid crystal panel control circuit 38 may further output detection sensitivity level information to set the detection sensitivity of the detecting sensor 11 to the sensor control circuit 35. The detection sensitivity level information may be included in the sensor driving instruction information and output to the sensor control circuit 35, or may be output to the sensor control circuit 35 separately from the sensor driving instruction information.

The detection sensitivity level information may be included in the image display content data, or may be set by the liquid crystal panel control circuit 38 according to the image display content type, or may be set beforehand by the user and stored in an unshown storage unit included within the display apparatus 1.

The sensor control circuit 35 is for the purpose of driving the detecting sensor 11 disposed in the display region to display an image from image display content which includes position input request information, with the image display content to display an image in the first display region 21a and image display content to display an image in the second display region 21b.

Upon obtaining the sensor driving instruction information from the liquid crystal panel control circuit 38, the sensor control circuit 35 drives a switch SW1 and switch SW2 that are connected to a detecting sensor 11 to be driven.

Upon obtaining the sensor detection sensitivity level information from the liquid crystal panel control circuit 38, the sensor control circuit 35 sets the detection sensitivity information of the detecting sensor 11 to be driven, so as to have a detection sensitivity corresponding to the obtained sensor detection sensitivity level information.

Further, the sensor control circuit 35 drives the coordinates detecting circuit 34 so as to have a detection sensitivity corresponding to the detection sensitivity level information obtained from the liquid crystal panel control circuit 38.

The detection sensitivity information is information to control the detection sensitivity of the detecting sensor 11 to be driven, and according to the present embodiment is a driving frequency.

Detection sensitivity of the detecting sensor 11 is increased by being driven at a high frequency. However, with the detecting sensor 11 being driven at a high frequency, the power consumption of the display apparatus 1 is increased.

On the other hand, detection sensitivity of the detecting sensor 11 is decreased by being driven at a low frequency. However, with the detecting sensor 11 being driven at a low frequency, the power consumption of the display apparatus 1 is decreased.

According to the present embodiment, the sensor control circuit 35 turns the switches SW1 and SW2 on and off at a driving frequency serving as the detection sensitivity corresponding to sensor detection sensitivity level information, while driving the integrated circuit of the coordinates detecting circuit 34 at this driving frequency.

Note that as a method to modify the detection sensitivity of the detecting sensor 11, besides setting the driving frequency, for example a method to change pulse waves that changes the voltage at driving or detecting of the detecting sensor 11 may be used.

The coordinates detecting circuit 34 has an integrated circuit. The coordinates detecting circuit 34 passes through the sensor electrodes (Y) 14, and obtains output voltage information of each detecting sensor 11 that is output via the switch SW2. The coordinates detecting circuit 34 then integrates the output voltage information of each detecting sensor 11 at the driving frequency indicated by the sensor detection sensitivity level information obtained from the sensor control circuit 35.

The coordinates detecting circuit 34 detects a contact position on the display screen 21 by the user, by integrating, of the detecting sensor 11 obtained via the switch SW2a, the voltage information from the detecting sensor 11 included in the region where the user is touching with a finger, which differs from the other region voltage information.

Thus, the coordinates detecting circuit 34 detects the coordinates on the display screen 21 where the user is touching with a finger, and outputs the detected coordinates to the sensor signal output unit 36.

The sensor signal output unit 36 is an interface to output the input position detected by the touch panel 10 to the outside of the touch panel 20. The sensor signal output unit 36 outputs the coordinates obtained from the coordinates detecting circuit 34, as information indicating an input position from the user, to the outside of the touch panel 20.

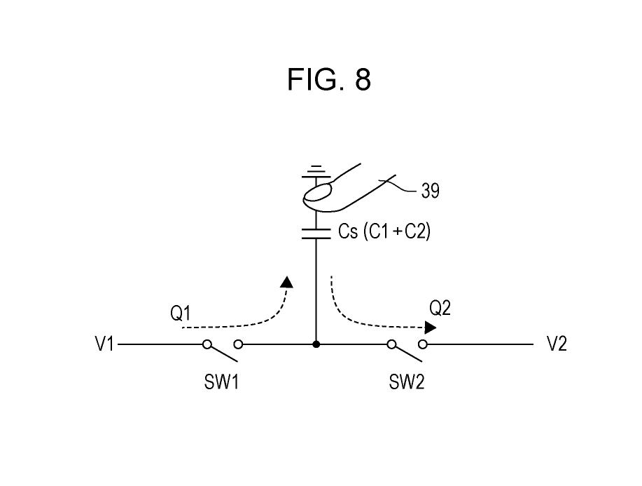

Next, a detecting method of a contact position as to the touch sensor 10 will be described using FIG. 7 and FIG. 8.

FIG. 8 is a diagram describing operating principles of the touch sensor 10.

As illustrated in FIG. 8, the touch sensor 10 is configured with a switched capacitor circuit.

In FIG. 8 the capacities C1 and C2 illustrated in FIG. 7 are together illustrated as capacitance Cs.

The switch SW1 and the switch SW2 are alternately turned on and off. The switching frequency at this time (i.e. the driving frequency of the detecting sensor 11) is fs.

An input pointer 39 touches the touch face 1a. Upon which, at the nearby touch sensor 10, movement of load from voltage V1 to voltage V2 occurs. The amount of load movement herein may be expressed as follows.

$$\begin{matrix}Q ( V 1 \to V 2 ) = Q 1 - Q 2 \\ = Cs ( V 1 - V 2 )\end{matrix}$$

The average current at this time may be expressed as follows below.

Iave=Q(V1−V2)/Δt

Cs(V1−V2)·fs

Thus, as seen from V1, equivalent resistance is Rs=fs/Cs.

The V2 that changes in according with the capacitance Changes of Cs is sampled, and capacitance Change is detected.

Thus, with the display apparatus 1, contact of the input pointer 39 is detected, and the position thereof identified.

Note that the detection method of the capacitance of the display apparatus 1 is not limited to the Grid method, and a CSA method or CSD method or the like may be used.

### (Detailed Description of the Block of Display Apparatus 101)

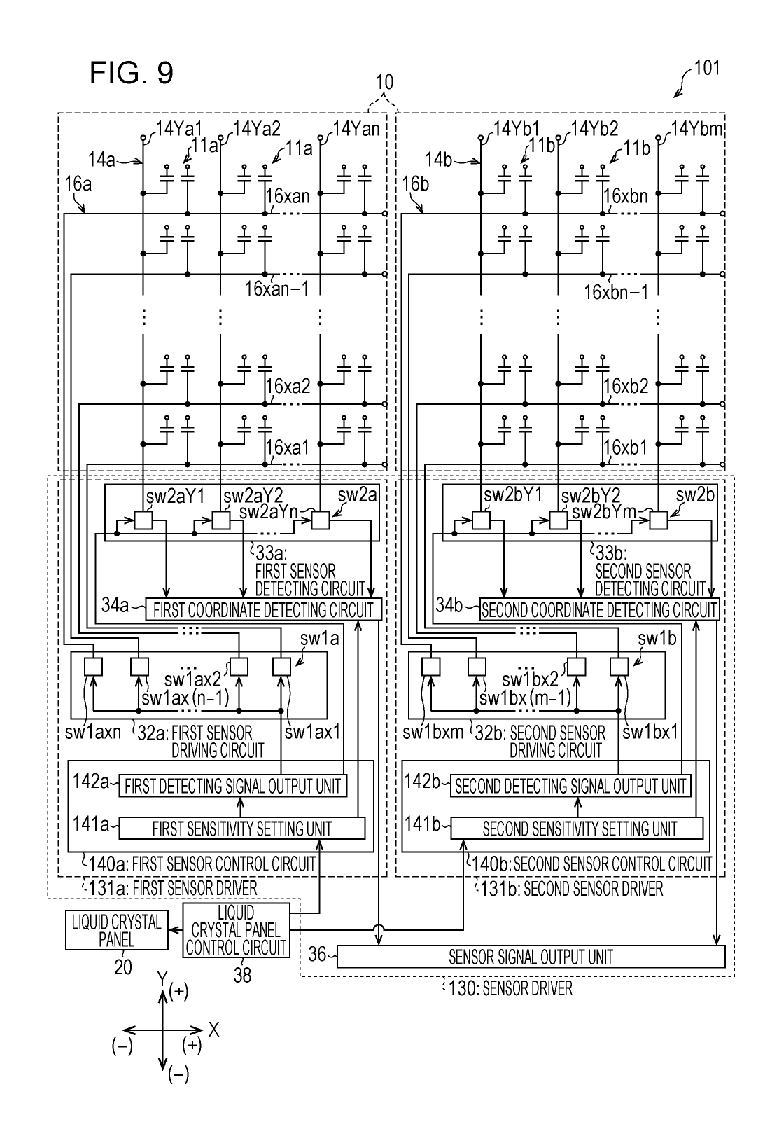

Next, a configuration of a display apparatus 101 will be described with reference to FIG. 9. FIG. 9 is a block diagram illustrating a configuration of the display apparatus 101.

The display apparatus 101 indicates a specific configuration of the display apparatus 1.

The display apparatus 101 has the above-described touch panel 10 and a sensor driver 130.

The sensor driver 130 has a first sensor driver 131a to control the driving of the first detecting sensor 11a of the touch sensor 10, a second sensor driver 131b to control the driving of the second detecting sensor 11b of the touch sensor 10, and a sensor signal output unit 36.

The first sensor driver 131a has a first sensor driving circuit 32a, a first sensor detecting circuit 33a, a first coordinates detecting circuit 34a, and a first sensor control circuit 140a.

The second sensor driver 131b has a second sensor driving circuit 32b, a second sensor detecting circuit 33b, a second coordinates detecting circuit 34b, and a second sensor control circuit 140b.

Each of the first sensor driving circuit 32a and second sensor driving circuit 32b, the first sensor detecting circuit 33a and second sensor detecting circuit 33b, the first coordinates detecting circuit 34a and second coordinates detecting circuit 34b, and the first sensor control circuit 140a and second sensor control circuit 140b correspond to the sensor driving circuit 32, sensor detecting circuit 33, coordinates detecting circuit 34, and sensor control circuit 35, respectively, of the display apparatus 1 illustrated in FIG. 7.

Also, the sensor electrodes (X) 16a and 16b, sensor electrodes (Y) 14a and 14b, and first detecting sensor 11a and second detecting sensor 11b, which correspond to the sensor electrodes (X) 16, sensor electrodes (Y) 14, and detecting sensor 11 of the display apparatus 1 illustrated in FIG. 7, are disposed in the touch panel 10 of the display apparatus 101.

The sensor electrode (X) 16a has a sensor electrode 16Xa1, 16Xa2, . . . , 16Xa(n−1), and 16Xan, which are arrayed in order, facing the Y plus direction (the direction from the bottom of the page toward the top) so as to be mutually parallel.

The sensor electrode (Y) 14 has a sensor electrode 14Ya1, 14Ya2, . . . , 14Ya(n−1), and 14Yan, which are arrayed in order, facing the X plus direction (the direction from the left of the page toward the right) so as to be mutually parallel.

The first detecting sensor 11a is disposed near the intersections of each of the sensor electrodes 16Xa1, 16Xa2, . . . , 16Xa(n−1), and 16Xan and the sensor electrodes 14Ya1, 14Ya2, . . . , 14Ya(n−1), and 14Yan.

The end portion on the opposite side from the open end of the capacitance C1 of the detecting sensor 11a is connected to each of the sensor electrodes 16Xa1, 16Xa2, . . . , 16Xa(n−1), and 16Xan, and the end portion on the opposite side from the open end of the capacitance C2 of the detecting sensor 11a is connected to each of the sensor electrodes 14Ya1, 14Ya2, . . . , 14Ya(n−1), and 14Yan.

The first sensor driving circuit 32a is a shift register, and further has a switch SW1a that corresponds to the switch SW1 of the display apparatus 1.

The switch SW1a has switches SW1aX1, SW1aX2, . . . , SW1aX(n−1), and SW1aXn. The switches SW1aX1, SW1aX2, . . . , SW1aX(n−1), and SW1aXn are each connected to the sensor electrodes 16Xa1, 16Xa2, . . . , 16Xa(n−1), and 16Xan, respectively, in order.

The first sensor driving circuit 33a is a shift register, and further has a switch SW2a that corresponds to the switch SW2 of the display apparatus 1.

The switch SW2a has switches SW2aY1, SW2aY2, . . . , SW2aY(n−1), and SW2aYn. The switches SW2aY1, SW2aY2, . . . , SW2aY(n−1), and SW2aYn are each connected to the sensor electrodes 14Ya1, 14Ya2, . . . , 14Ya(n−1), and 14Yan, respectively, in order.

The sensor electrode (X) 16b has sensor electrodes 16Xb1 and 16Xb2, . . . , 16Xb(n−1), and 16Xbn which are arrayed in order, facing the Y plus direction (the direction from the bottom of the page toward the top) so as to be mutually parallel.

The sensor electrode (Y) 14b has a sensor electrode 14Yb1, 14Yb2, . . . , 14Yb(m−1), and 14Ybm, which are arrayed in order, facing the X plus direction (the direction from the left of the page toward the right) so as to be mutually parallel.

The first detecting sensor 11b is disposed near the intersections of each of the sensor electrodes 16Xb1, 16Xb2, . . . , 16Xb(n−1), and 16Xbn and the sensor electrodes 14Yb1, 14Yb2, . . . , 14Yb(m−1), and 14Ybm.

The end portion on the opposite side from the open end of the capacitance C1 of the detecting sensor 11b is connected to each of the sensor electrodes 16Xb1, 16Xb2, . . . , 16Xb(n−1), and 16Xbn, and the end portion on the opposite side from the open end of the capacitance C2 of the detecting sensor 11b is connected to each of the sensor electrodes 14Yb1, 14Yb2, . . . , 14Yb(m−1), and 14Ybm.

The first sensor driving circuit 32b is a shift register, and further has a switch SW1b that corresponds to the switch SW1 of the display apparatus 1.

The switch SW1b has switches SW1bX1, SW1bX2, . . . , SW1bX(n−1), and SW1bXn. The switches SW1bX1, SW1bX2, . . . , SW1bX(n−1), and SW1bXn are each connected to the sensor electrodes 16Xb1, 16Xb2, . . . , 16Xb(n−1), and 16Xbn, respectively, in order.

The first sensor driving circuit 33b is a shift register, and further has a switch SW2b that corresponds to the switch SW2 of the display apparatus 1.

The switch SW2b has switches SW2bX1, SW2bX2, . . . , SW2bX(m−1), and SW2bXm. The switches SW2bX1, SW2bX2, . . . , SW2bX(m−1), and SW2bXm are each connected to the sensor electrodes 14Yb1, 14Yb2, . . . , 14Yb(m−1), and 14Ybm, respectively, in order.

The first sensor control circuit 140a has a first sensitivity setting unit 141a and a first detecting signal output unit (first driving signal output means) 142a. The first sensor control circuit 140b has a first sensitivity setting unit 141b and a first detecting signal output unit (second driving signal output means) 142b.

The first sensitivity setting unit 141a sets the detection sensitivity information of the first detecting sensor 11a to the detection sensitivity that corresponds to the sensor detection sensitivity level information obtained from the liquid crystal panel control circuit 38, thereby setting the detection sensitivity of the first detecting sensor 11a according to the image displayed in the first display region 21a.

The first sensitivity setting unit 141a sets the driving frequency (e.g. approximately 1 Hz) to the detection sensitivity corresponding to the sensor detection sensitivity level information obtained from the liquid crystal panel control circuit 38, serving as detection sensitivity information of the first detecting sensor 11a, to generate a driving signal.

The first sensitivity setting unit 141a outputs the driving signal, set with the above-mentioned driving frequency, to the first detecting signal output unit 142a and first coordinates detecting circuit 34a.

The first detecting signal output unit 142a drives the switches SW1a and SW2a with the detection sensitivity information set by the first sensitivity setting unit 141a.

The first detecting signal output unit 142a scans and sequentially drives the switch SW1a included in the first sensor driving circuit 32a and the switch SW2a included in the first sensor detecting circuit 33a, with the driving frequency (driving signal) indicated by the detection sensitivity information obtained from the first sensitivity setting unit 141a, thereby driving the first detecting sensor 11a at the set driving frequency indicated by the detection sensitivity information.

The second sensitivity setting unit 141b sets the detection sensitivity information of the second detecting sensor 11b to the detection sensitivity that corresponds to the sensor detection sensitivity level information obtained from the liquid crystal panel control circuit 38, thereby setting the detection sensitivity of the second detecting sensor 11b according to the image displayed in the second display region 21b.

The second sensitivity setting unit 141b sets the driving frequency (e.g. approximately 120 Hz) to the detection sensitivity corresponding to the sensor detection sensitivity level information obtained from the liquid crystal panel control circuit 38, serving as detection sensitivity information of the second detecting sensor 11b, to generate a driving signal.

The second sensitivity setting unit 141b outputs the driving signal, set with the above-mentioned driving frequency, to the second detecting signal output unit 142b and second coordinates detecting circuit 34b.

The second detecting signal output unit 142b drives the switches SW1b and SW2b with the detection sensitivity information set by the second sensitivity setting unit 141b.

The second detecting signal output unit 142b scans and sequentially drives the switch SW1b included in the second sensor driving circuit 32b and the switch SW2b included in the second sensor detecting circuit 33b, with the driving frequency (driving signal) indicated by the detection sensitivity information obtained from the second sensitivity setting unit 141b, thereby driving the second detecting sensor 11b at the driving frequency set by the detection sensitivity information.

Thus, the second detecting signal output unit 142b outputs a driving signal that differs from the driving signal that the detecting signal output unit 142a outputs to the first detecting sensor 11a. Thus, the sensitivity of detecting the user contact position that is touching the first display region 21a of the first detecting sensor 11a and the sensitivity of detecting the user contact position that is touching the second display region 21b of the first detecting sensor 11b may be differentiated. Thus, a display apparatus 101 having a touch panel function preventing poor usability for the user, such as the possibility of operation error or input error increasing, and which reduces power consumption, can be provided.

Also, the method to differentiate the detection sensitivity between the first detecting sensor 11a and second detecting sensor 11b is not limited to differing driving frequencies, and for example, a pulse waveform of the driving signal that the first detecting signal output unit 142a outputs to the first detecting sensor 11a and a pulse waveform of the driving signal that the second detecting signal output unit 142b outputs to the second detecting sensor 11b may differ, whereby the detection sensitivity of the first detecting sensor 11a and the detection sensitivity of the second detecting sensor 11b is differentiated.

Also, the detection sensitivity of the first detecting sensor 11a and the detection sensitivity of the second detecting sensor 11b may be differentiated by differentiating the driving voltage of the driving signal that the first detecting signal output unit 142a outputs to the first detecting sensor 11a and the driving voltage of the driving signal that the second detecting signal output unit 142b outputs to the second detecting sensor 11b.

### (Processing Flow of Display Apparatus 101)

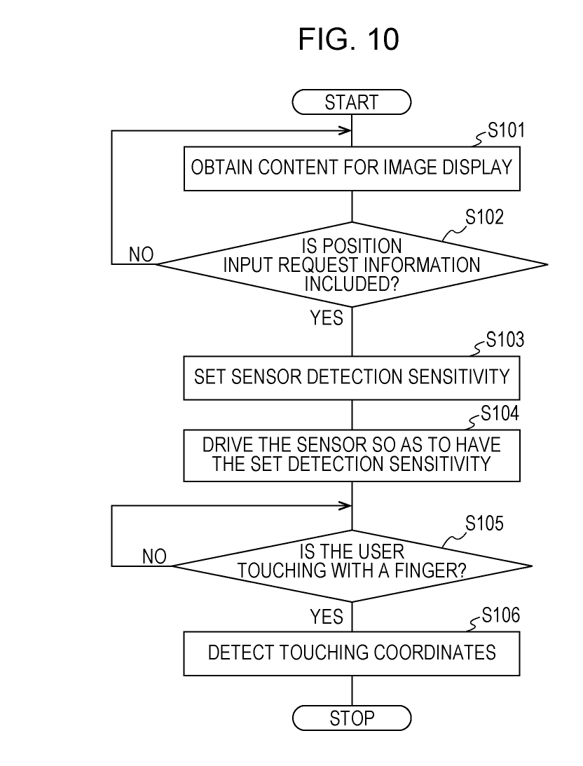

Next, a processing flow to detect coordinates on the display apparatus 101 will be described with reference to FIG. 10.

Note that the processing flow to detect coordinates are the same for the first detecting sensor 11a and the second detecting sensor 11b of the display apparatus 101, so the processing flow to detect coordinates for the first detecting sensor 11a will be described here, and the description for the second detecting sensor 11b will be omitted.

FIG. 10 is a flowchart describing the processing flow to detect coordinates on the display apparatus 101.

The liquid crystal panel control circuit 38 obtains image display content to display an image in the first display region 21a (step S101).

Upon obtaining the image display content, the liquid crystal panel control circuit 38 outputs image display instruction information to display an image of the image display content to the liquid crystal panel 20, while determining whether or not position input request information to receive position input from the user is included in the image display content (step S102).

Upon determining that position input request information is included in the image display content (YES in step S102), the liquid crystal panel control circuit 38 outputs the sensor driving instruction information to drive the first detecting sensor 11a to the first sensitivity setting unit 353a.

Now, detection sensitivity level information to set the detection sensitivity of the first detecting sensor 11a is included beforehand in the sensor driving instruction information.

The detection sensitivity level information of the first detecting sensor 11a may be included in the data of the image display content, may be set by the liquid crystal panel control circuit 38 according to the type of the image display content, or may be set by the user beforehand.

Upon obtaining the sensor driving instruction information from the liquid crystal panel control circuit 38, the first sensitivity setting unit 141a sets the detection sensitivity information of the first detecting sensor 11a to be the detection sensitivity that corresponding to the sensor detection sensitivity level information that is included in the sensor driving instruction information.

Now, as detection sensitivity information, the first sensitivity setting unit 141a sets the driving frequency of the first detecting sensor 11a to be the detection sensitivity that corresponds to the above-mentioned obtained sensor detection sensitivity level information.

The first sensitivity setting unit 141a generates a driving signal of a 1 Hz driving frequency, for example.

Thus, the first sensitivity setting unit 141a sets the detection sensitivity of the first detecting sensor 11a (step S103) in accordance with the image to be displayed in the first display region 21a.

Note that by the second sensitivity setting unit 141b generating a driving signal which is a 120 Hz driving frequency, for example, the second sensitivity setting unit 141b sets the detection sensitivity of the second detecting sensor 11b in accordance with the image displayed in the second display region 21b.

The first sensitivity setting unit 141a outputs the above-mentioned detection sensitivity information that has been set to the first detecting signal output unit 142a, while outputting also to the first coordinates detecting circuit 34a.

Upon obtaining the detection sensitivity information obtained from the first sensitivity setting unit 353a, the first detection signal output unit 352a scans and sequentially drives the switch SW1a included in the first sensor driving circuit 32a and the switch SW2a included in the first sensor detecting circuit 33a, with the driving frequency indicated by the obtained detection sensitivity information, thereby driving the first detecting sensor 11a at the set driving frequency indicated by the detection sensitivity information.

That is to say, the first detecting signal output unit 352a drives the first detecting sensor 11a so as to have the detection sensitivity set by the first sensitivity setting unit 353a (step S104).

Upon the user touching with a finger or the like within the region that the first detecting sensor 11a is disposed (YES in step S105), the voltage information indicating contact is output from the first detecting sensor 11a which is included in the region that the finger or the like has touched to the first coordinates detecting circuit 34a via the switch SW2 that is connected to the first detecting sensor 11a.

The first coordinates detecting circuit 34a integrates the voltage information of the first detecting sensors 11a that is output from the switches SW2a of the first sensor detecting circuit 33a with the driving frequency indicated by the detection sensitivity information obtained from the first sensitivity setting unit 141a.

As an example, the first coordinates detecting circuit 34a integrates the voltage information of the first detecting sensors 11a that is output from the switches SW2a of the first sensor detecting circuit 33a, at 1 Hz.

Note that the second coordinates detecting circuit 34b integrates the voltage information of the second detecting sensors 11b that is output from the switches SW2b of the second sensor detecting circuit 33b, at 120 Hz.

The first coordinates detecting circuit 34a detects the contact position of the user by integrating, of the first detecting sensors 11a, obtained via the switches SW2a, the voltage information from the first detecting sensor 11a included in the region where the user has touched with a finger, which differs from the voltage information of other regions.

That is to say, the first coordinates detecting circuit 34a detects the coordinates where the user has touched with a finger (step S106). The first coordinates detecting circuit 34a outputs the detected coordinates to the sensor signal output unit 36.

The sensor signal output unit 36 outputs the coordinates obtained from the first coordinates detecting circuit 34a to the outside, as an input position from the user.

Thus, the contact position of the user touching the first display region 21a can be detected.

The second sensitivity setting unit 141b, second detecting signal output unit 142b, second sensor driving circuit 32b, second sensor detecting circuit 33b, and second coordinates detecting circuit 34b can also perform detection of the contact position of the user to the second display region 21b, by performing similar processing as the above-described first sensitivity setting unit 141a, first detecting signal output unit 142a, first sensor driving circuit 32a, first sensor detecting circuit 33a, and first coordinates detecting circuit 34a.

### (Usage Example)

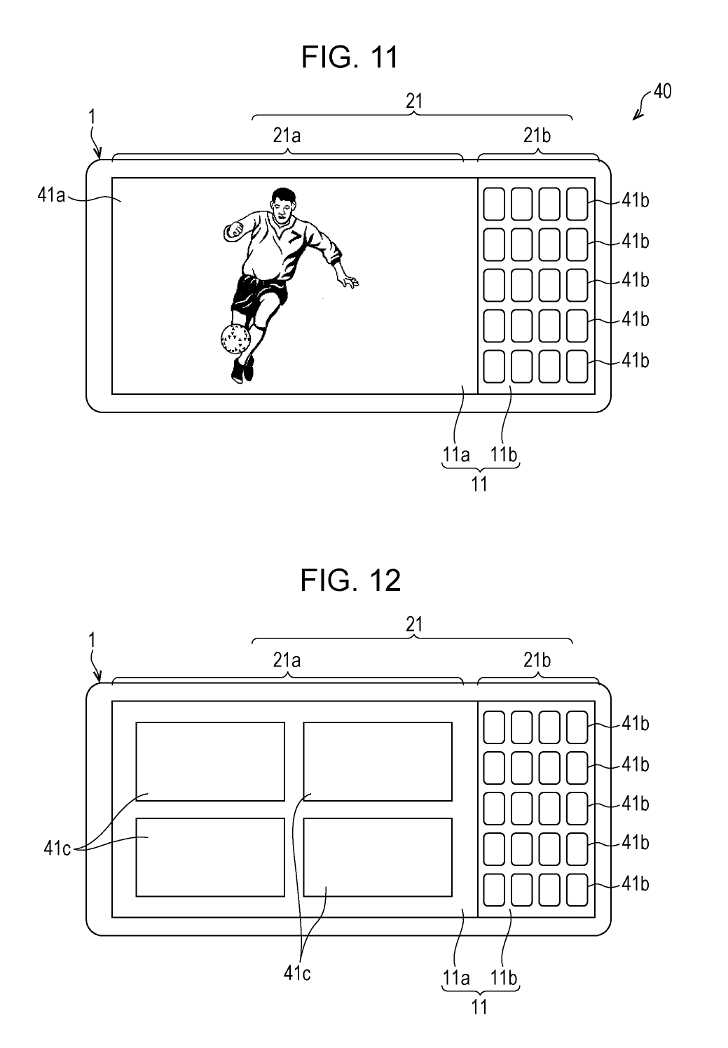

A usage example of the display apparatus 1 will be described with reference to FIG. 11.

FIG. 11 is a diagram to describe a usage example of the display apparatus 1. As an example, the case of using the display apparatus 1 as a television will be described.

The display apparatus 1 has a television image 41a displayed on a first display region 21a having a large area of the display screen 21, and multiple content selection buttons 41b for the user to select content are displayed on a second display region 21b having a small area.

An image including such content selection buttons 41b is a display image to request position input to the user.

The first display region 21a has an aspect ratio (horizontal length:vertical length) of 16:9. Therefore, a full high-definition broadcast image of a digital television received by the display apparatus 1 does not have to be scaled, and can be displayed in the first display region 21a without change.

The second display region 21b has an aspect ratio (horizontal length:vertical length) of 5:9.

Accordingly, the aspect ratio of the display screen 21 having the first display region 21a and second display region 21b is 21:9. Therefore, an image for a movie does not have to be scaled, and can be displayed on the display screen 21 without change.

According to the display apparatus 1, a first detecting sensor 11a having a relatively low sensitivity to detect the user contact position within the display screen 21 is disposed in the first display region 21a that displays a television image for the primary purpose of the user to watch. Thus, as compared to a case where the touch sensor 10 having a high sensitivity to detect the user contact position within the display screen 21 is disposed over the entire display screen 21, power consumption can be decreased.

An image indicating a large number of content selection buttons 41b (input image) is displayed on the second display region 21b so as to function as a user interface. Disposed in the second display region 21b is a second detecting sensor 11b, having a relatively higher sensitivity to detect the user contact position within the display screen 21 than the first detecting sensor 11a. Therefore, usability becoming poor for the user because of detection sensitivity decreasing when the user selects one of the multiple content selection buttons 41b can be prevented.

Thus, a display apparatus 1 having a touch panel function in which usability is poor for the user is prevented, and which reduces power consumption, can be provided.

Also, according to the display apparatus 1, the first display region 21a of the display apparatus 1 has an area larger than the second display region 21b, whereby the area for the user contact position within the display screen 21 to be detected by the first detecting sensor 11a is large, enabling decreasing power consumption.

Also, as illustrated in FIG. 12, a content selection button 41c having a larger area than the content button 41b may be displayed in the first display region 21a. According to the display apparatus 1, the first detecting sensor 11a is disposed also in the first display region 21a, whereby the user can select one of the multiple content selection buttons 41c displayed in the first display region 21a.

Thus, the touch sensor 10 is disposed over the entire face of the display screen 21, whereby the display apparatus 1, the contact position of the input pointer 39 from the user can be detected over the entire face of the display screen 21. Therefore, an image for a user interface can be displayed over the entire face of the display screen 21 to detect the contact position of the input pointer 39 of the user. Therefore, since the region that can detect the user contact position in the display screen 21 is not limited, convenience and ease of use by the user are great.

Note that the touch sensor 10 does not necessarily have to be disposed over the entire face of the display screen 21, and may be disposed on only a partial region within the display screen 21.

Also, the display apparatus 1 can be applied, not only a television, but to electronic devices for which a touch panel function is requested, and additionally can be applied to various types of PC (personal computer) such as a monitor for a desktop PC, notebook PC, tablet PC and the like, and various types of mobile devices such as a cellular phone, mobile gaming devices, vehicle navigation systems, and the like. Further, the display apparatus 1 can be applied to an information display or over other entire displays having a touch panel (sensor panel).

As illustrated in FIG. 11, in the case that content selection buttons are not displayed on the first display region 11a, i.e. in the case of displaying an image that does not request position input from the user, the second detecting sensor 11b only, which is disposed in the second display region 11b on which the content selection buttons 41b are displayed, may be driven, without driving the first detecting sensor 11a.

Thus, power consumption to drive the detecting sensor 11 can be further prevented.

### (Display Apparatus of On-Cell Type)

According to the above-described display apparatus 1, description has been given as a configuration of an out-cell type of touch panel. However, the display apparatus 1 may be configured in other touch panel configurations.

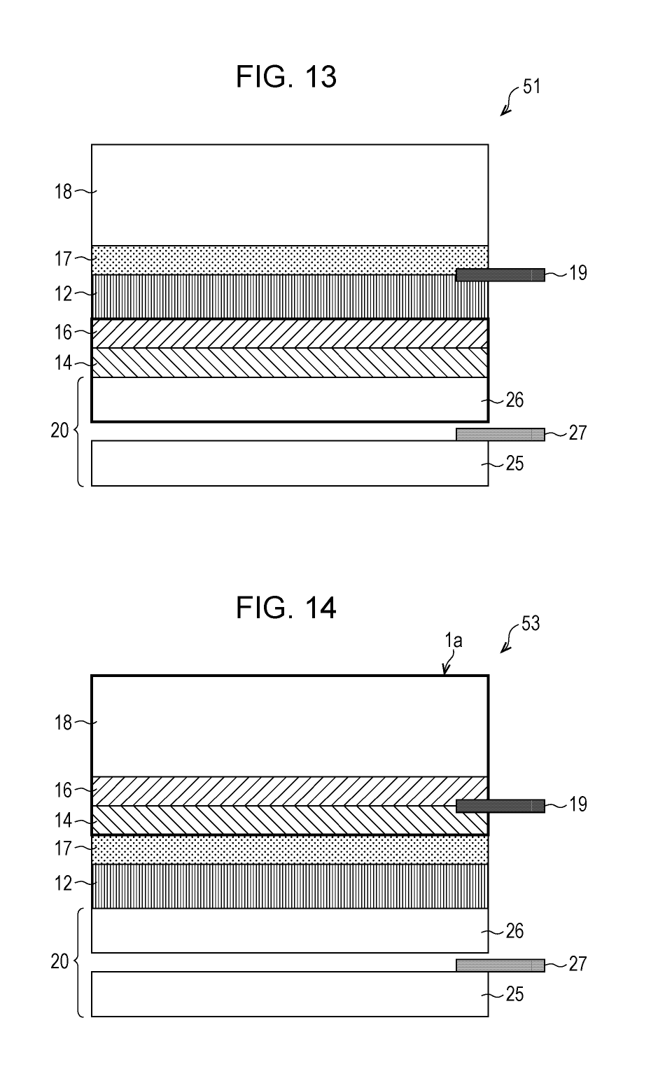

FIG. 13 is a cross-sectional diagram illustrating a configuration of an on-cell type of touch panel.

As illustrated in FIG. 13, the display apparatus 51 is configured, layered in order from the bottom layer side to the top layer side of the facing glass substrate 26 of the liquid crystal panel, a sensor electrode (Y) 14, sensor electrode (X) 16, a polarizer 12, optical adhesive 17, and cover glass 18. Also, one end portion of a FPC 27 is disposed between a TFT glass substrate 25 and facing glass substrate 26. Also, one end portion of a FPC 19 is disposed between the polarizer 12 and sensor electrode (X) 16.

According to such a configuration of the display apparatus 51, compared to an out-cell type of configuration such as the above-described display apparatus 1, the display apparatus can be made thinner, and costs can be reduced.

### (Other On-Cell Type Display Apparatus)

FIG. 14 is a cross-sectional diagram illustrating a configuration of another on-cell type of touch panel.

As illustrated in FIG. 14, a display apparatus 53 is configured, layered in order from the bottom layer side to the top layer side, on the front face of the facing glass substrate 26 of the liquid crystal panel 20, a polarizer 12, optical adhesive 17, sensor electrode (Y) 14, sensor electrode (X) 16, and cover glass 18. Also, one end portion of a FPC 27 is disposed between a TFT glass substrate 25 and facing glass substrate 26. Also, one end portion of a FPC 19 is disposed between the sensor electrode (Y) 14 and sensor electrode (X) 16. As an example, the thickness of the cover glass 18 is approximately 0.8 mm.

According to such a configuration of the display apparatus 53, the sensor electrode (Y) 14 and sensor electrode (X) 16 are near the touch face 1a, whereby noise can be reduced.

### (In-Cell Type Display Apparatus)

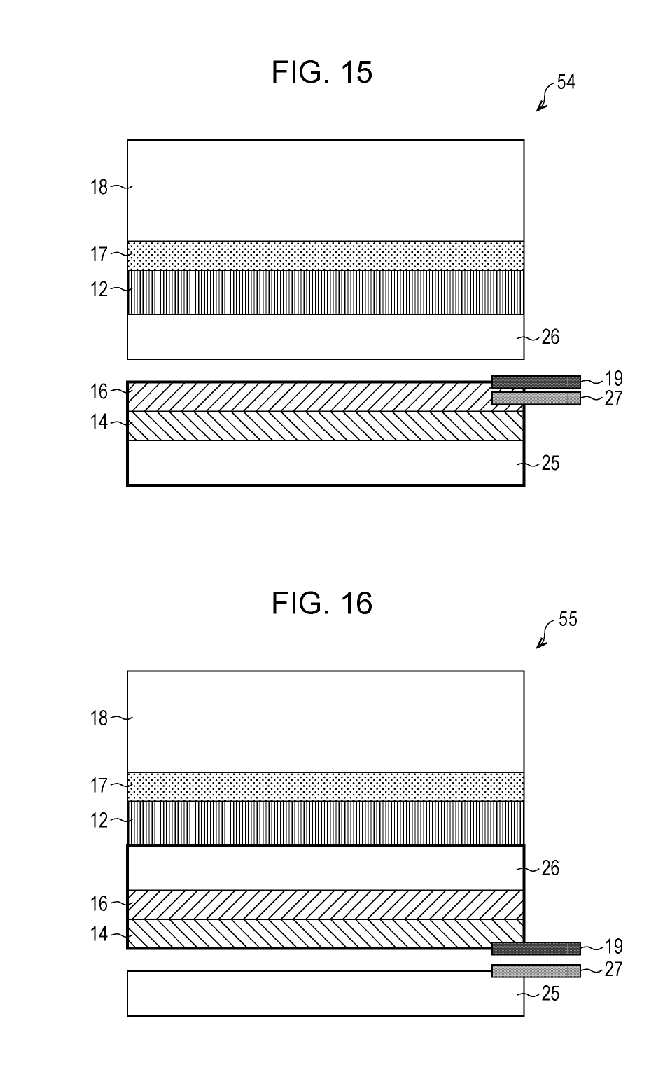

FIG. 15 is a cross-sectional diagram illustrating a configuration of an in-cell type of touch panel.

As illustrated in FIG. 15, a display apparatus 54 has a sensor electrode (Y) 14 and sensor electrode (X) 16, layered sequentially, on a TFT glass substrate 25. Also, the TFT glass substrate 25 and a facing glass substrate 26 are disposed so as to face each other via a liquid crystal layer.

Further, a display apparatus 54 is configured, layered in order from the bottom layer side to the top layer side, on the front face of the facing glass substrate 26, a polarizer 12, optical adhesive 17, and cover glass 18. Also, one end portion of the FPC 27 and one end portion of the FPC 19 are disposed between the TFT glass substrate 25 and facing glass substrate 26. As an example, the thickness of the facing glass substrate 26, polarizer 12, optical adhesive 17, and cover glass 18 together is approximately 1.5 mm.

According to such a configuration of the display apparatus 54, compared to an out-cell type of configuration, the display apparatus can be made thinner, and costs can be reduced. Also, a display apparatus having minimal sensor cost (additional layers) can be obtained. However, influence of image display noise is great.

### (Other In-Cell Type Display Apparatus)

FIG. 16 is a cross-sectional diagram illustrating the configuration of another in-cell type of touch panel.

As illustrated in FIG. 16, a display apparatus 55 is configured, disposed on the face of the facing glass substrate 26 facing the TFT glass substrate 25, in order from the TFT glass substrate 25 side, a sensor electrode (X) 16 and sensor electrode (Y) 14. Also, a facing glass substrate 26 is which a sensor electrode (X) 16 and sensor electrode (Y) 14 are disposed and a TFT glass substrate 25 are disposed so as to be facing each other, via a liquid crystal layer.

Further, the display apparatus 55 is configured, layered in order from the bottom layer side to the top level side on the front face of the facing glass substrate 26 (opposite face from the side wherein the sensor electrode (X) 16 is disposed), a polarizer 12, optical adhesive 17, and cover glass 18. Also, one end portion of the FPC 27 and one end portion of the FPC 19 are disposed between the TFT glass substrate 25 and facing glass substrate 26. One end portion of the FPC 19 is disposed so as to be in contact with the sensor electrode (Y) 14 that is disposed on the facing glass substrate 26, and one end portion of the FPC 27 is disposed so as to be in contact with the TFT glass substrate 25.

As an example, the thickness of the facing glass substrate 26, polarizer 12, optical adhesive 17, and cover glass 18 together is approximately 1.5 mm.

According to such a configuration of the display apparatus 55, compared to an out-cell type of configuration, the display apparatus can be made thinner, and costs can be reduced. Also, alignment precision is high. An advantage is that modularizing is simple. However, influence of image display noise is great.

### Second Embodiment

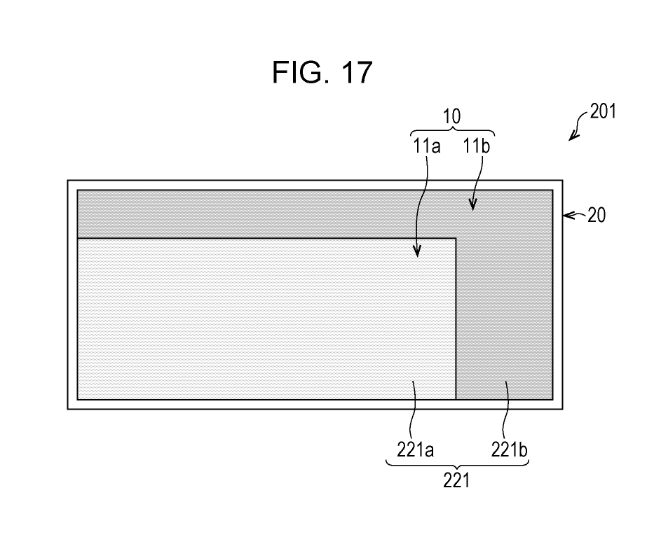

A second embodiment according to the present invention will be described with reference to FIGS. 17 through 19. Note that where a member has the same function as in a diagram described for the first embodiment above, for ease of description, the same reference numerals will be appended thereto and the description thereof will be omitted.

### (Configuration of Display Apparatus 201)

FIG. 17 is a diagram illustrating a configuration of the display apparatus 201 relating to the second embodiment of the present invention.

As illustrated in FIG. 17, the display apparatus 201 with the display apparatuses 1 and 101 described according to the first embodiment, the areas of each of the first display region 21a and second display region 21b of the display screen 21 are fixed, and are not variable.

On the other hand, according to the display apparatus 201 relating to the present embodiment, the areas of each of the first display region 21a and second display region 21b of the display screen 221 are configured so as to be changeable. Thus, the display apparatus 201 is a display apparatus having high general use capability.

According to the display apparatus 201, in accordance with changing the areas of each of the first display region 21a and second display region 21b of the display screen 221, each of the first detecting sensor 11a disposed in the first display region 21a and the second detecting sensor 11b disposed in the second display region 21b are also changed.

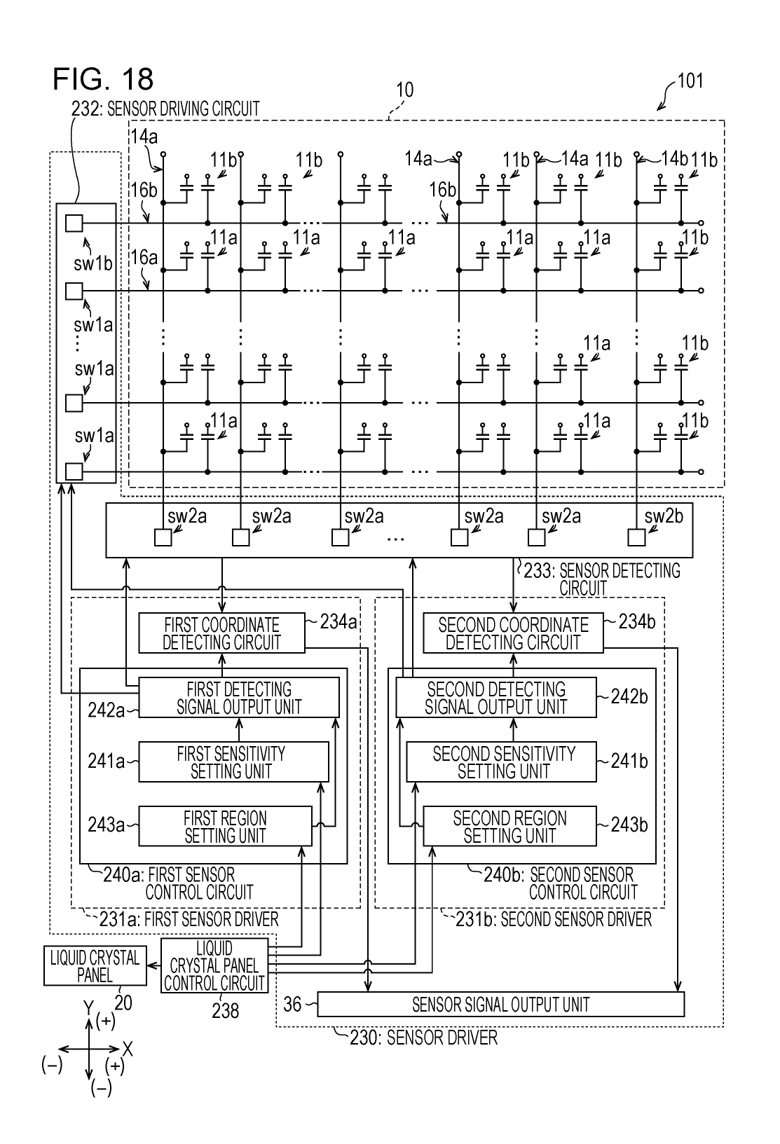

FIG. 18 is a block diagram illustrating a configuration of a display apparatus 201.

The display apparatus 201 has a touch sensor 10, sensor driver 230, liquid crystal panel 20, and liquid crystal panel control circuit 38.

The sensor driver 230 has a first sensor driver 231a to control the driving of the first detecting sensor 11a of the touch sensor 10, a second sensor driver 231b to control the driving of the second detecting sensor 11b of the touch sensor 10, a sensor driving circuit 232, sensor detecting circuit 233, and sensor signal output unit 36.

The first sensor driver 231a has a first sensor control circuit 240a and first coordinates detecting circuit 234a. The second sensor driver 231b has a second sensor control circuit 240b and second coordinates detecting circuit 234b.

The first sensor control circuit 240a has a first sensitivity setting unit 241a, first detecting signal output unit 242a, and first region setting unit 243a. The second sensor control circuit 240b has a second sensitivity setting unit 241b, second detecting signal output unit 242b, and second region setting unit 243b.

The first region setting unit 243a sets and identifies the detecting sensor 11 included in the first display region 22a and the switches SW1a and SW2a, based on instructions from the liquid crystal panel control circuit 238. The first region setting unit 243a then outputs the identifying information of the identified detecting sensor 11 and switches SW1a and SW2a to the first detecting signal output unit 242a.

The second region setting unit 243b sets and identifies the detecting sensor 11 included in the second display region 22b and the switches SW1b and SW2b, based on instructions from the liquid crystal panel control circuit 238. The second region setting unit 243b then outputs the identifying information of the identified detecting sensor 11 and switches SW1b and SW2b to the second detecting signal output unit 242b.

The first sensitivity setting unit 241a sets the sensitivity information of the detecting sensor 11 and switches SW1a and SW2a set by the first region setting unit 243a. The first sensitivity setting unit 241a sets the driving frequency of the detecting sensor 11 and switches SW1a and SW2a set by the first region setting unit 243a, and generates a driving signal.

The second sensitivity setting unit 241b sets the sensitivity information of the detecting sensor 11 and switches SW1b and SW2b set by the second region setting unit 243b. The second sensitivity setting unit 241b sets the driving frequency of the detecting sensor 11 and switches SW1b and SW2b set by the second region setting unit 243b, and generates a driving signal.

The first detecting signal output unit 242a drives the switches SW1a and SW2a at the driving frequency of the driving signal generated by the first sensitivity setting unit 241a. Also, the second detecting signal output unit 242b drives the switches SW1b and SW2b at the driving frequency of the driving signal generated by the second sensitivity setting unit 241b.

The sensor driving circuit 232 has a switch SW1a and switch SW1b arrayed lined up together. The sensor detecting circuit 233 has a switch SW2a and switch SW2b arrayed lined up together.

### (Processing Flow of Display Apparatus 201)

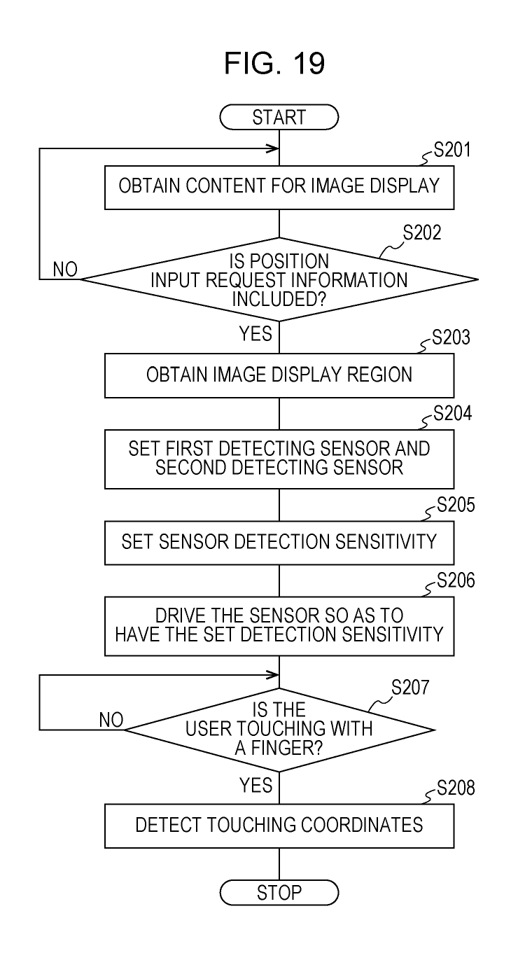

Next, the processing flow to detect the coordinates of the display apparatus 201 will be described with reference to FIG. 19.

Note that the processing flow to detect coordinates are the same for the first detecting sensor 11a and the second detecting sensor 11b of the display apparatus 201, so the processing flow to detect coordinates for the first detecting sensor 11a will be described here, and the description for the second detecting sensor 11b will be omitted.

FIG. 19 is a flowchart describing the processing flow to detect coordinates on the display apparatus 201.

The liquid crystal panel control circuit 238 obtains image display content to display an image in the first display region 221a (step S201).

Upon obtaining the image display content, the liquid crystal panel control circuit 38 outputs image display instruction information to display an image of the image display content to the liquid crystal panel 20, while determining whether or not position input request information to receive position input from the user is included in the image display content (step S202).

Upon determining that position input request information is included in the image display content (YES in step S202), the liquid crystal panel control circuit 238 outputs the sensor driving instruction information to drive the first detecting sensor 11a to the first sensitivity setting unit 241a and to the first region setting unit 243a.

Now, detection sensitivity level information to set the detection sensitivity of the first detecting sensor 11a is included beforehand in the sensor driving instruction information.

The detection sensitivity level information of the first detecting sensor 11a may be included in the data of the image display content, may be set by the liquid crystal panel control circuit 238 according to the type of the image display content, or may be set by the user beforehand.

Also, information indicating the position of the first display region 221a of the display screen 221 is included beforehand in the sensor driving instruction information. The setting of the position of the first display region 221a of the display screen 221 may be made beforehand by the user, may be set by the liquid crystal panel control circuit 238 according to the type of image display content, or may be included in the data of the image display content.

Upon obtaining the sensor driving instruction information from the liquid crystal panel control circuit 238, the first region setting unit 243a sets the detecting sensor 11 within a region that will be the first display region 221a as the first detecting sensor 11a (step S204) from the information indicating the position of the first display region 221a, and also, of the switches SW1 and SW2, sets the switches SW1a and SW2a to drive the above-mentioned set first detecting sensor 11a.

The first region setting unit 243a then outputs the identifying information of the switch SW1a/switch SW2a that has been set, to the first detecting signal output unit 242a.

Also, upon obtaining the sensor driving instruction information from the liquid crystal panel control circuit 238, the first sensitivity setting unit 241a sets the detection sensitivity information of the first detecting sensor 11a to be the detection sensitivity that corresponds of the sensor detection sensitivity level information included in the sensor driving instruction information.

Now, the first sensitivity setting unit 241a generates a driving signal with the driving frequency of the first detecting sensor 11a being set so as to be the detection sensitivity that corresponds to the sensor detection sensitivity level information that has been obtained.

Thus, the first sensitivity setting unit 241a sets the detection sensitivity of the first detecting sensor 11a (step S205) according to the image displayed in the first display region 221a, and generates a driving signal.

The first sensitivity setting unit 241a then outputs the above-mentioned detection sensitivity information that has been set to the first detecting signal output unit 242a, while also outputting to the first coordinates detecting circuit 234a.

Upon obtaining information indicating the positions of the first detecting sensor 11a and switches SW1a and SW2a from the first region setting unit 243, and obtaining detection sensitivity information from the first sensitivity setting unit 241a, the first detection signal output unit 242a scans and sequentially drives the switches SW1a and SW2a included in the identifying information of the switches SW1a and SW2a obtained from the first region setting unit 243, at the set driving frequency indicated by the detection sensitivity information.

Thus, the first detecting signal output unit 242a drives the first detecting sensor 11a set by the first region setting unit 243a, at the set driving frequency indicated by the detection sensitivity information.

That is to say, the first detecting signal output unit 242a drives the first detecting sensor 11a that has been set by the first region setting unit 243a, so as to have the detection sensitivity set by the first sensitivity setting unit 241a (step S206).

Upon the user touching with a finger or the like within the region that the first detecting sensor 11a is disposed (YES in step S207), voltage information indicating contact is output from the first detecting sensor 11a included in the region where the finger or the like has touched to the first coordinates detecting circuit 234a via the switch SW2a that is connected to the first detecting sensor 11a.

The first coordinates detecting circuit 234a integrates the voltage information of the first detecting sensors 11a output from the switches SW2a of the first detecting circuit 33 with the driving frequency indicated by the detection sensitivity information obtained from the first sensitivity setting unit 241a.

The first coordinates detecting circuit 234a integrates the voltage information from the first detecting sensor 11a included in the region where the user has touched with a finger, which differs from the voltage information of other regions, of the first detecting sensors 11a obtained via the switches SW2a, thereby detecting the contact position of the user.

That is to say, the first coordinates detecting circuit 234a detects the coordinates where the user has touched with a finger (step S208). The first coordinates detecting circuit 234a outputs the detected coordinates to the sensor signal output unit 36.

The sensor signal output unit 36 outputs, to the outside, the coordinates obtained from the first coordinates detecting circuit 234a, as an input position from the user.

Note that each of the second region setting unit 243b, second sensitivity setting unit 241b, and second detecting signal output unit 242b also perform the same processing as the above-described first region setting unit 243a, first sensitivity setting unit 241a, and first detecting signal output unit 242a.

According to the display apparatus 201, the positions of the first detecting sensor 11a and second detecting sensor 11b can be changed.

For example, in the case that only the 2×2 detecting sensor 11a at the upper right on the page having high sensitivity is desired (in the case of desiring to set as the second detecting sensor 11b), a 120 Hz driving signal is output to just the top two lines by the sensor driving circuit 232, and a 1 Hz driving signal is output to the rest. Further, with the sensor detecting circuit 233, only the two columns from the right of the page are detected with 120 Hz (integrating the output voltage), and the others are detected with 1 Hz (integrating the output voltage).

Also, the method to differentiate the detection sensitivity of the detecting sensor 11 may be a method whereby, for example, the driving frequency of the driving signal output from the sensor driving circuit 232 is fixed (to approximately 60 Hz or the like), and the number of integrations of the second detecting sensor 11b is changed according to the region.

### Third Embodiment

### (Configuration of Display Apparatus 301)

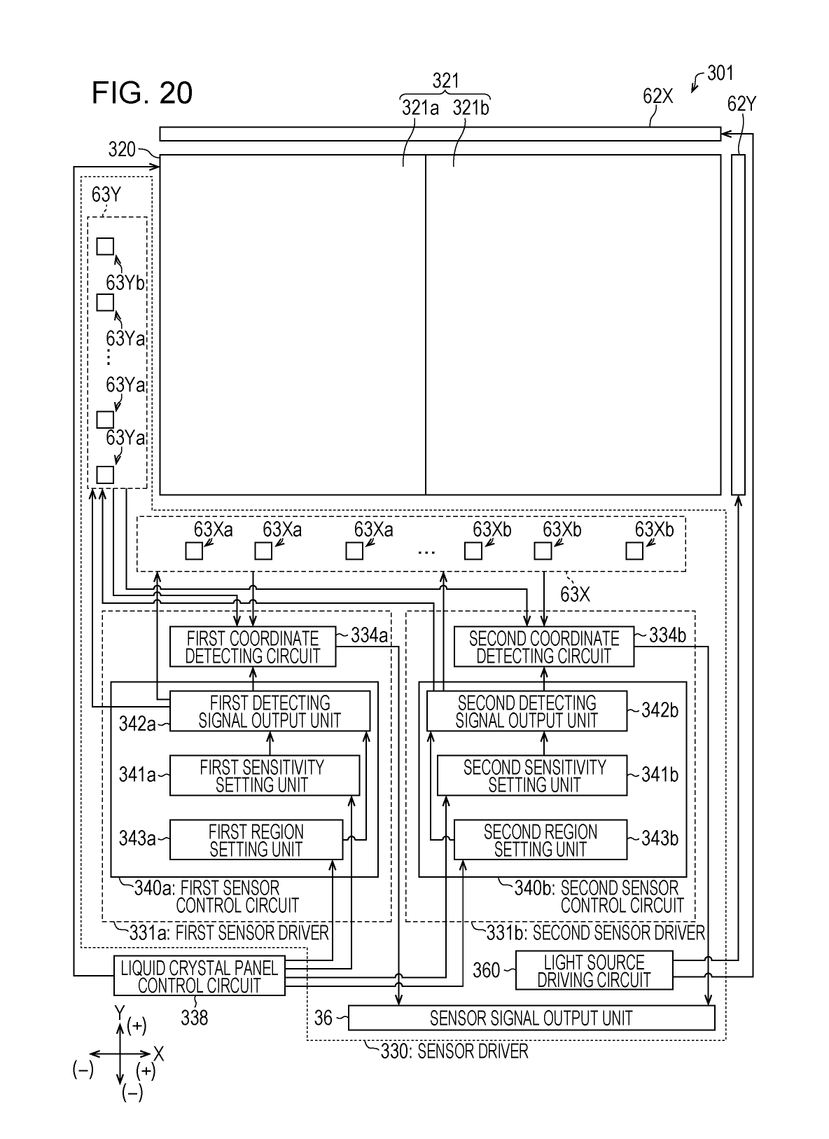

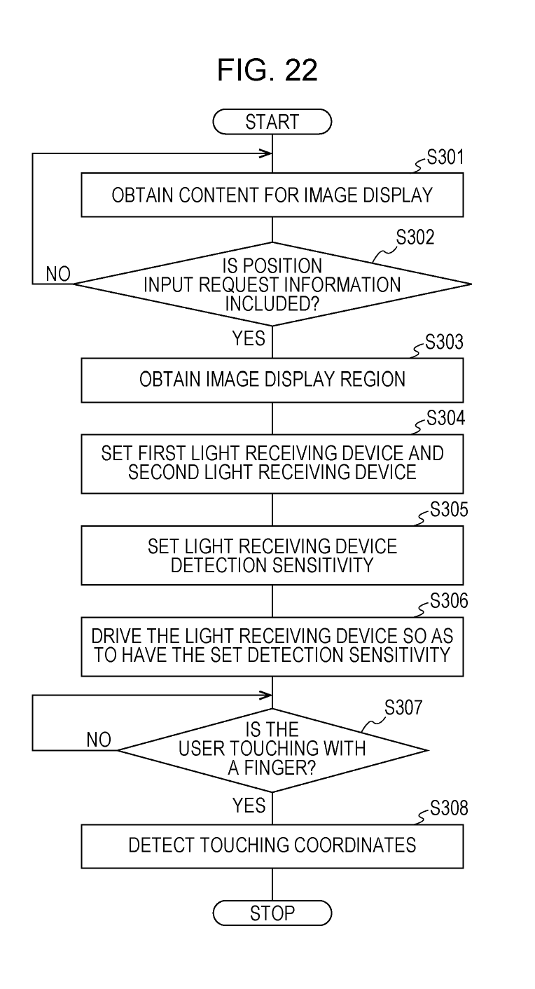

Next, a display apparatus 301 relating to a third embodiment of the present invention will be described with reference to FIGS. 20 through 22.

The touch sensor 10 of the display apparatus 1 described above has been described as having a capacitance method. However, the display apparatus 1 may have another method of touch sensors.

FIG. 20 is a plan view illustrating a configuration of the display apparatus 301. FIG. 16 is a cross-sectional diagram illustrating the configuration of the display apparatus 301.

The display apparatus 301 has an optical type of touch sensor (position detecting sensor) 60 instead of the touch sensor 10 that the display apparatus 1 has.

According to the display apparatus 301, the entire face of the display screen 21 is a region where the contact position of the input pointer 39 can be detected by the optical type touch sensor 60. When viewing the display apparatus 301 in plan view, the touch sensor 60 is disposed along the periphery of the display screen 21.

The touch sensor 60 has a light source group 62X and a light receiving element group 63X to detect a contact position in the X direction of the display screen 21, and a light source group 62Y and a light receiving element group 63Y to detect a contact position in the Y direction of the display screen 21.

The light source groups 62X and 62Y are configured from multiple LED devices, for example, and emit infrared (IR) light.

The light source groups 62X and 62Y are disposed on a substrate 64 provided to a region along the periphery of the display screen 21.

The light source group 62X is provided along the end portions in the vertical direction (Y direction) of the display screen 21 adjacent to the second display region 21b. The light source group 62Y is provided along the end portions in the horizontal direction (X direction) of the display screen 21.

The light receiving element groups 63X and 63Y are configured from phototransistors, for example, and receive infrared light and output current to the outside according to the light amount of the received infrared light.

The light receiving element groups 63X and 63Y are disposed in a row on the substrate 64 that is provided to a region along the periphery of the display screen 21.

The light receiving element group 63X is provided along the end portion in the horizontal direction (X direction) adjacent to the display screen 21. That is to say, the light receiving element group 63X is disposed in a region that faces the light source group 62X. Thus, the light receiving element group 63X receives the infrared light emitted by the light source group 62X.

The light receiving element group 63X has a first light receiving element 63Xa to detect a contact position of the input pointer 39 to the first display screen 21a, and a second light receiving element 63Xb to detect a contact position of the input pointer 39 to the second display screen 21b. The first light receiving element group 63Xa is disposed along one edge of the first display screen 21a. The second light receiving element 63Xb is disposed along one edge of the second display screen 21b.

The light receiving element group 63Y is provided along the end portion in the vertical direction (Y direction) of the display screen 21. That is to say, the light receiving device group 63Y is disposed in a region facing the light source group 62Y, via the display screen 21. Thus, the light receiving element group 63Y receives the infrared light emitted by the light source group 62Y.

Also, the display apparatus 301 has a sensor driver 330 to control each of the light source groups 62X and 62Y and the light receiving element groups 63X and 63Y.

Further, the display apparatus 301 has a polarizer 12 disposed on the front face of the liquid crystal panel 20, a transparent cover glass 68 disposed on the front face of the polarizer 12, and a bezel 67 disposed surrounding the light source groups 62X and 62Y and the light receiving groups 63X and 63Y in the periphery of the display screen 21.

The front face of the cover glass 68 of the display apparatus 70 is a touch face 1a, and is a display screen 21.

The display apparatus 70 has a lens 65 that is disposed on the substrate 64 and near an emitting face of infrared light of the light source group 62X, and a lens 66 that is disposed on the substrate 64 and near a light receiving face of the phototransistor 63.

The infrared light emitted from the light source group 62X (light source group 62Y) transmits through the lens 65, advances along the front face of the cover glass 68, transmits through the lens 66, and is received by the light receiving element group 63X (light receiving element group 63Y).

Upon the user touching with the input pointer 39 such as a finger or the like to the touch face 1a in order to input a position from the touch face 1a, the light emitted from the light source group 62X and light source group 62Y is blocked by the touching input pointer 39. According to the display apparatus 70, the positions in the blocked X direction and Y directions can be detected by the light receiving element groups 63X and 63Y, whereby a touch panel function can be realized.

According to the touch sensor 60, the sensitivity to detect a touch to the display screen 321 differs between the first display region 321a and the second display region 321b. That is to say, the detection sensitivities differ between the first light receiving element 63Xa and the second light receiving element 63Xb.

According to the present embodiment, compared to the first light receiving element 63Xa to detect the contact position of the input pointer 39 to the first display region 21a, the light receiving element 63Xb to detect the contact position of the input pointer 39 to the second display region 21b has a higher light receiving sensitivity to the infrared light emitted from the light source group 62X. Thus, compared to the first display region 21a, the touch sensor 60 in the second display region 21b has a higher detection sensitivity to input positions.

The display apparatus 301 further has a liquid crystal panel control circuit 338 and a sensor driver 330.

The sensor driver 330 has a first sensor driver 331a to control the driving of the first light receiving element 63Xa and the light receiving element group 63Y, and a second sensor driver 331b to control the driving of the second light receiving element 63Xb.

The first sensor driver 331a has a first sensor control circuit 340a and a first coordinates detecting circuit 334a. The first sensor control circuit 340a has a first region setting unit 343a, first sensitivity setting unit 341a, and first detecting signal output unit 342a.

The second sensor driver 331b has a second sensor control circuit 340b and a second coordinates detecting circuit 334b. The second sensor control circuit 340b has a second region setting unit 343b, second sensitivity setting unit 341b, and second detecting signal output unit 342b.

The first region setting unit 343a sets the light receiving element group 63X to detect contact within the region serving as the first display region 321a as a first light receiving element 63Xa, based on instructions from the liquid crystal panel control circuit 338, and outputs the identifying information of the first light receiving element 63Xa that has been set, to the first detecting signal output unit 342a.

The second region setting unit 343b sets the light receiving element group 63X to detect contact within the region serving as the second display region 321b as a second light receiving element 63Xb, based on instructions from the liquid crystal panel control circuit 338, and outputs the identifying information of the second light receiving element 63Xb that has been set, to the second detecting signal output unit 342a.

### (Processing Flow of Display Apparatus 301)

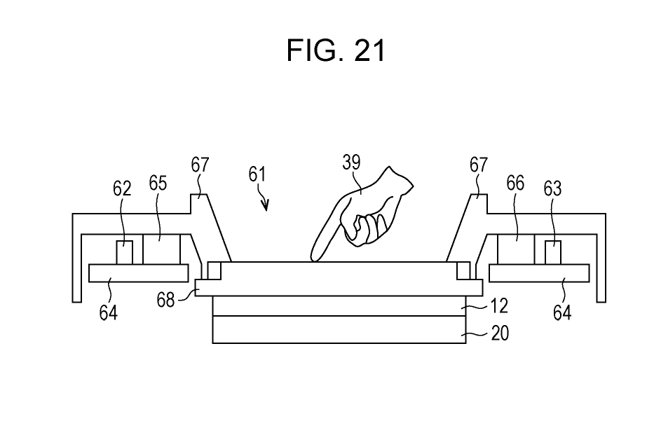

Next, the processing flow to detect the coordinates of the display apparatus 301 will be described with reference to FIG. 21.

Note that the processing flow to detect coordinates are the same for the first light receiving element 63Xa and the second light receiving element 63Xb of the display apparatus 301, so the processing flow to detect coordinates for the first light receiving element 63Xa will be described here, and the description for the second detecting sensor 11b will be omitted.

FIG. 21 is a flowchart describing the processing flow to detect coordinates on the display apparatus 301.

The liquid crystal panel control circuit 338 obtains image display content to display an image in the first display region 321a (step S301).

Upon obtaining the image display content, the liquid crystal panel control circuit 338 outputs image display instruction information to display an image of the image display content to the liquid crystal panel 320, while determining whether or not position input request information to receive position input from the user is included in the image display content (step S302).

Upon the liquid crystal panel control circuit 338 determining that position input request information is included in the image display content (YES in step S302), the liquid crystal panel control circuit 338 outputs the sensor driving instruction information to drive the first light receiving element 63Xa and light receiving element group 63Y to the first sensitivity setting unit 341a and to the first region setting unit 343a.

Now, detection sensitivity level information to set the detection sensitivity of the first light receiving element 63Xa and light receiving element group 63Y is included beforehand in the sensor driving instruction information.

The detection sensitivity level information of the first light receiving element 63Xa and light receiving element group 63Y may be included in the data of the image display content, may be set by the liquid crystal panel control circuit 338 according to the type of the image display content, or may be set by the user beforehand.

Also, information indicating the position of the first display region 321a of the display screen 321 is included beforehand in the sensor driving instruction information. The setting of the position of the first display region 321a of the display screen 321 may be made beforehand by the user, may be set by the liquid crystal panel control circuit 338 according to the type of image display content, or may be included in the data of the image display content.

Upon obtaining the sensor driving instruction information from the liquid crystal panel control circuit 338, the first region setting unit 343a sets the light receiving element group 63X to detect contact within a region to serve as a first display region 321a from the information indicating the position of the first display region 321a, as the first light receiving element 63Xa (step S304), and outputs the identifying information of the first light receiving element 63Xa that has been set to the first detecting signal output unit 342a.

Also, upon obtaining the sensor driving instruction information from the liquid crystal panel control circuit 338, the first sensitivity setting unit 341a sets the detection sensitivity information of the first light receiving element 63Xa so as to have the detection sensitivity corresponding to the sensor detecting sensitivity level information included in the sensor driving instruction information.

Now, the first sensitivity setting unit 341a sets the driving frequency of the first light receiving element 63Xa, as detection sensitivity information, so as to have the detection sensitivity corresponding to the obtained sensor detection sensitivity level information.

Thus, the first sensitivity setting unit 341a sets the detection sensitivity of the first light receiving element 63Xa according to the image displayed in the first display region 321a (step S305), and generates a driving signal.

The first sensitivity setting unit 341a outputs the set driving signal to the first detecting signal output unit 342a, while also outputting to the first coordinates detecting circuit 334a.

Upon obtaining information indicating the position of the first light receiving element 63Xa from the first region setting unit 343, and obtaining detection sensitivity information from the first sensitivity setting unit 341a, the first detecting signal output unit 342a scans and sequentially drives the first light receiving element 63Xa included in the identifying information of the first light receiving element 63Xa obtained from the first region setting unit 343.

Also, the first detecting signal output unit 342a scans and sequentially drives the light receiving element group 63Y at a driving frequency indicated by the detection sensitivity information obtained from the first sensitivity setting unit 341a.

Thus, the first detecting signal output unit 342a drives the first light receiving element 63Xa and light receiving element group 63Y set by the first region setting unit 343a with a set driving frequency indicated by the detection sensitivity information.

That is to say, the first detecting signal output unit 342a drives the first light receiving element 63Xa so that the first light receiving element 63Xa which has been set by the first region setting unit 343a is at the detection sensitivity set by the first sensitivity setting unit 341a (step S306), while driving the light receiving element group 63Y so that the light receiving element group 63Y is also at the detection sensitivity set by the first sensitivity setting unit 341a.

Upon the user touching with a finger or the like within the first display region 321a (YES in step S307), voltage information indicating contact is output from the first light receiving element 63Xa and light receiving element group 63Y to detect contact within the region where the finger or the like has touched to the first coordinates detecting circuit 334a.

The first coordinates detecting circuit 334a integrates the voltage information output from the first light receiving element 63Xa and light receiving element group 63Y with the driving frequency indicated by the detection sensitivity information obtained from the first sensitivity setting unit 341a.

The first coordinates detecting circuit 334a integrates the voltage information from the first light receiving element 63Xa included in the region where the user has touched with a finger, which differs from the voltage information of other regions, of the first light receiving elements 63Xa, thereby detecting the contact position of the user.

That is to say, the first coordinates detecting circuit 334a detects the coordinates where the user has touched with a finger (step S308). The first coordinates detecting circuit 334a outputs the detected coordinates to the sensor signal output unit 36.

The sensor signal output unit 36 outputs, to the outside, the coordinates obtained from the first coordinates detecting circuit 334a, as an input position from the user.

Note that the second region setting unit 343b, second sensitivity setting unit 341b, second detecting signal output unit 342b, and second coordinates detecting circuit 334b also perform the same processing as the above-described first region setting unit 343a, first sensitivity setting unit 341a, first detecting signal output unit 342a, and first coordinate detecting circuit 334a.

The display apparatus 301 thus has an optical-type touch sensor 60 instead of a capacitor type, so screen size can be increased readily. That is to say, the sensor pattern formation process of the touch sensor 60 is not needed, and the signal does not decay as much as with electrical resistance.

Note that the optical type touch sensor 60 has a configuration of a frame protruding, and therefore the above-described capacitor type is optimal for a mobile device.

The present invention is not limited to the embodiments described above, and various types of modifications can be made within the scope set forth in the Claims, and embodiments which are obtained by appropriately combining the technical means disclosed in each of the different embodiments are also included in the technical scope of the present invention.

In order to solve the above problems, a display apparatus having a touch panel function, has a display screen to display an image; and multiple position detecting sensors to detect the instruction position of a user to the display screen; wherein the multiple position detecting sensors have multiple first position detecting sensors having a relatively low sensitivity to detect the instruction position of a user to the display screen; and multiple second position detecting sensors having a relatively high sensitivity to detect the instruction position of the user to the display screen, as compared to the multiple first position detecting sensors.

According to the above configuration, multiple position detecting sensors are provided, whereby the instruction position of a user to the display screen can be detected.

According to the above configuration, the multiple position detecting sensors have a first position detecting sensor group having a relatively low sensitivity to detect the user instruction position to the display screen. Thus, power consumption can be reduced as compared to the case of being formed from only position detecting sensors having high sensitivity to detect the user instruction position to the display screen.

Further, according to the above configuration, the multiple position detecting sensors have a second position detecting sensor having relatively higher sensitivity than the first position detecting sensor, to detect the user instruction position to the display screen.

Thus, on the display screen, with the second position detecting sensor, an image to accept input from the user (an input image) is primarily displayed in a region to detect the user contact position to the display screen, thereby preventing poor usability due to decreased sensitivity to detect the user contact position.

Thus, according to the above configuration, a display apparatus having a touch panel function preventing poor usability for the user, and which reduces power consumption, can be provided.

Also, it is desirable to have first driving signal output means that output a driving signal to the first position detecting sensor, and second driving signal output means that output a driving signal, which differs from the driving signal output to the first position detecting sensor, to the second position detecting sensor.

According to the above configuration, the sensitivity to detect the user instruction position of the first position detecting sensor and the sensitivity to detect the user instruction position of the second position detecting sensor can be differentiated. Thus, a display apparatus having a touch panel function preventing poor usability for the user, and which reduces power consumption, can be provided.

Also, it is desirable for the driving frequency of the driving signal that the first driving signal output means output to the first position detecting sensor to differ from the driving frequency of the driving signal that the first driving signal output means output to the first position detecting sensor.

Also, it is desirable for the pulse waveform of the driving signal that the first driving signal output means output to the first position detecting sensor to differ from the pulse waveform of the driving signal that the first driving signal output means output to the first position detecting sensor.

Also, it is desirable for the driving voltage of the driving signal that the first driving signal output means output to the first position detecting sensor to differ from the driving voltage of the driving signal that the first driving signal output means output to the first position detecting sensor.

According to the above configuration, the sensitivity to detect the user contact position with the first position detecting sensor and the sensitivity to detect the user contact position with the second position detecting sensor can be differentiated. Thus, a display apparatus having a touch panel function preventing poor usability for the user, and which reduces power consumption, can be provided.

Also, it is desirable for the multiple position detecting sensors to be disposed to enable detection of the user instruction position over the entire face of the display screen. According to the above configuration, an image to accept input from the user can be displayed, and the user instruction position can be detected, over the entire face of the display screen. Therefore, the region of the display screen in which the user contact position can be detected is not limited, so a display apparatus having great convenience and ease of use by the user can be provided.

Also, it is desirable for the display screen to have a first display region in which the user contact position to the display screen is detected by the first position detecting sensor, and a second display region in which the user contact position to the display screen is detected by the second position detecting sensor.

According to the above configuration, a display apparatus having a touch panel function preventing poor usability for the user, and which reduces power consumption, can be provided, by the first display region in the display screen lowering the frequency of displaying the input image, and the second display region increasing the frequency of displaying the input image.

Also, it is desirable for the first display region to have a larger area than the second display region.

According to the above configuration, the area that the user contact position to the display screen is detected is large because of the first position detecting sensor group, whereby power consumption can be reduced.

Also, it is desirable for the area of the first display region and the area of the second display region to be variable. According to the above configuration, a display apparatus having high general use can be obtained.

Also, when viewing from a plan view, it is desirable for multiple position detecting sensors to be disposed within the display screen, and for the multiple position detecting sensors to detect the user contact position to the display screen with a capacitance method.

Also, when viewing from a plan view, it is desirable for the multiple position detecting sensors to be disposed along the periphery of the display screen, and for the multiple position detecting sensors to detect the user instruction position to the display screen with an optical method.

According to the above configuration, a display apparatus can be obtained at a lower cost as compared to the case of realizing a touch panel function with an electromagnetic dielectric method.

Also, it is desirable for the aspect ratio of the first display region to be 16:9. According to the above configuration, the aspect ratio (horizontal length:vertical length) of the first display region is 16:9, so a full high definition broadcast image of digital television can be displayed in the first display region without change.

Also, it is desirable for the aspect ratio of the second display region to be 5:9. According to the above configuration, the aspect ratio of the display screen will be 21:9, so a movie image can be displayed without scaling on the display screen without change.

### INDUSTRIAL APPLICABILITY

The present invention can be widely applied to a touch panel to display position input and images.

### REFERENCE SIGNS LIST

1, 51, 53, 54, 55, 201, 301 display apparatus
1a touch face
10 touch sensor
11a first sensor (first position detecting sensor)
11b second sensor (second position detecting sensor)
14 sensor electrode
16 sensor electrode
18 cover glass
20 liquid crystal panel
21 display screen
21a first display region
21b second display region
31 sensor driver
32 driving circuit
33 detecting circuit
34 coordinates detecting circuit
35 touch sensor control circuit
38 liquid crystal panel control circuit
39 input pointer
41a television image
41b content selecting button
41c content selecting button
60 touch sensor
62X light source group
62X, 62Y light source group (touch sensor)
63X, 63Y light receiving element group (touch sensor)
63Xa light receiving element (first position detecting sensor)
63Xb light receiving element (second position detecting sensor)

1. A display apparatus having a touch panel function, comprising:
a display screen to display an image; and
a plurality of position detecting sensors to detect the instruction position of a user to the display screen; wherein
the plurality of position detecting sensors has
a plurality of first position detecting sensors having a relatively low sensitivity to detect the instruction position of a user to the display screen; and
a plurality of second position detecting sensors having a relatively high sensitivity to detect the instruction position of the user to the display screen, as compared to the plurality of first position detecting sensors.

2. The display apparatus according to claim 1, further comprising:
a first driving signal output unit configured to output a driving signal to the first position detecting sensor; and
a second driving signal output unit configured to output a driving signal that differs from the driving signal output to the first position detecting sensor.

3. The display apparatus according to claim 2, wherein the driving frequency of the driving signal that the first driving signal output unit outputs to the first position detecting sensor and the driving frequency of the driving signal that the second driving signal output unit outputs to the second position detecting sensor are different.

4. The display apparatus according to claim 2, wherein the pulse waveform of the driving signal that the first driving signal output unit outputs to the first position detecting sensor and the pulse waveform of the driving signal that the second driving signal output unit outputs to the second position detecting sensor are different.

5. The display apparatus according to claim 2, wherein the driving voltage of the driving signal that the first driving signal output unit outputs to the first position detecting sensor and the driving voltage of the driving signal that the second driving signal output unit outputs to the second position detecting sensor are different.

6. The display apparatus according to claim 1, wherein the plurality of position detecting sensors are disposed so as to enable detection of user instruction position over the entire face of the display screen.

7. The display apparatus according to claim 1, wherein the display screen has a first display region in which the instruction position of the user to the display screen is detected by the first position detecting sensor, and a second display region in which the instruction position of the user to the display screen is detected by the second position detecting sensor.

8. The display apparatus according to claim 7, wherein the area of the first display region is larger than the second display region.

9. The display apparatus according to claim 7, wherein the area of the first display region and the area of the second display region are variable.

10. The display apparatus according to claim 1, wherein, when viewed as a plan view, the plurality of position detecting sensors are disposed within the display screen;
and wherein the plurality of position detecting sensors detect the instruction position of the user to the display screen using a capacitance method.

11. The display apparatus according to claim 1, wherein, when viewed as a plan view, the plurality of position detecting sensors are disposed along the periphery of the display screen;
and wherein the plurality of position detecting sensors detect the instruction position of the user to the display screen using an optical method.

12. The display apparatus according to claim 7, wherein the aspect ratio of the first display region is 16:9.

13. The display apparatus according to claim 12, wherein the aspect ratio of the second display region is 5:9.
